(19) United States
(12) Patent Application Publication
(10) Pub. No.: US 2017/0120122 A1
(43) Pub. Date: May 4, 2017

(54) ELECTRONIC APPARATUS, SYSTEM, METHOD, PROGRAM, AND RECORDING MEDIUM

(71) Applicant: SEIKO EPSON CORPORATION, Tokyo (JP)

(72) Inventor: Norihisa HAGIWARA, Hachioji-shi (JP)

(73) Assignee: SEIKO EPSON CORPORATION, Tokyo (JP)

(21) Appl. No.: 15/292,607

(22) Filed: Oct. 13, 2016

(30) Foreign Application Priority Data
Nov. 2, 2015 (JP) 2015-215810

(51) Int. Cl. A63B 60/46; G09B 19/00; A63B 24/00

(52) U.S. Cl. CPC A63B 60/46; A63B 24/0006; G09B 19/0038; A63B 2102/32

(57) ABSTRACT

An electronic apparatus includes a presentation portion that divides each of time-series data items regarding a plurality of swings of an exercise equipment into sections of a predetermined number, and presents a variation between the time-series data items in the swings for each section.

### BACKGROUND

1. Technical Field

The present invention relates to an electronic apparatus, a system, a method, a program, and a recording medium.

2. Related Art

In the related art, an analysis system has been proposed which displays a player's swing trajectory which is divided into a backswing, a downswing, and follow-through, on the basis of a captured image of a golf swing (refer to JP-A-2013-240506). The player can recognize an outline of the swing thereof on the basis of this display.

However, in the analysis system of the related art, a player cannot check whether or not a swing is stable, that is, the extent of reproducibility of the swing. Since an apparatus which simultaneously displays a plurality of swing trajectories has already been proposed, a user can check deviation of a trajectory, but required times among a plurality of swing trajectories are frequently different from each other, and thus there is a problem in that it is hard for the user to objectively estimate the reproducibility of the swing on the basis of the deviation of a trajectory.

### SUMMARY

An advantage of some aspects of the invention is to provide an electronic apparatus, a system, a method, a program, and a recording medium, capable of performing objective evaluation of reproducibility of a swing.

The invention can be implemented as the following forms or application examples.

### Application Example 1

An electronic apparatus according to this application example includes a presentation portion that divides each of time-series data items regarding a plurality of swings of an exercise equipment into sections of a predetermined number, and presents a variation between the time-series data items in the swings for each section.

The presentation portion presents a variation for each section by equally setting the number of sections among the plurality of time-series data items even if the number of samples differs among the plurality of time-series data items. The variation for each section is an index which quantitatively indicates deviation of a plurality of swing trajectories in detail. Therefore, according to the electronic apparatus of the application example, it is possible to objectively estimate reproducibility of a swing.

### Application Example 2

In the electronic apparatus according to the application example, the presentation portion may present the variation along with a predetermined region, and the predetermined region may be a region interposed between a first plane along a longitudinal direction of the exercise equipment and a second plane passing through the vicinity of the shoulder of a user, the first plane being a plane specified by a first axis along a target hit ball direction and a second axis along the longitudinal direction of the exercise equipment before starting the swing, and the second plane being a plane which includes the first axis and forms a predetermined angle with the first plane, or a plane which is parallel to the first plane.

Therefore, the user can check a relationship between the predetermined region and the variation.

### Application Example 3

An electronic apparatus according to this application example includes a calculation portion that divides each of a plurality of time-series data items regarding a plurality of swings into sections of a predetermined number, and calculates a variation between the time-series data items in the swings for each section.

The calculation portion calculates a variation for each section by equally setting the number of sections among the plurality of time-series data items even if the number of samples differs among the plurality of time-series data items. The variation for each section is an index which quantitatively indicates deviation of a plurality of swing trajectories in detail. Therefore, the electronic apparatus according to the application example can objectively estimate reproducibility of a swing.

### Application Example 4

In the electronic apparatus according to the application example, the calculation portion may divide each of the plurality of time-series data items regarding positions of an exercise equipment or a user's body into sections of a predetermined number, calculate the positions for each swing and for each section, and calculate a variation between the positions in swings for each section on the basis of the positions for each swing and for each section, an average of the positions in the swings for each section, and the number of swings.

The calculation portion calculates a variation between the positions in swings for each section on the basis of the positions for each swing and for each section, an average of the positions in the swings, and the number of swings. Therefore, the electronic apparatus can acquire, for example, a standard deviation as a variation for each section.

### Application Example 5

In the electronic apparatus according to the application example, each of the positions for each section may be an average value or a representative value of the positions in the section.

The calculation portion calculates an average value or a representative value of the positions in the section as each of the positions for each section. Therefore, the calculation portion can reliably reduce the number of samples of positions required to calculate a variation.

### Application Example 6

In the electronic apparatus according to the application example, the variation may be a standard deviation.

Therefore, the electronic apparatus can acquire a standard deviation as a variation for each section.

### Application Example 7

In the electronic apparatus according to the application example, the calculation portion may calculate the variation on the basis of output from an inertial sensor.

The inertial sensor can accurately measure a position of a predetermined portion of an exercise equipment or a user. Therefore, the calculation portion can accurately calculate a variation compared with a case of calculating a variation on the basis of a swing image or the like.

### Application Example 8

In the electronic apparatus according to the application example, the time-series data is at least one of time-series data from starting of the swing to impact, time-series data from starting of the swing to a top, and time-series data from the top to the impact.

Therefore, the electronic apparatus can set, as a variation presentation target or calculation target, a period from a predetermined timing of the swing to another predetermined timing thereof.

### Application Example 9

In the electronic apparatus according to the application example, temporal lengths of the sections of the predetermined number may be set to be uniform.

Therefore, the electronic apparatus can present or calculate a variation for each section which is uniform in a time direction.

### Application Example 10

In the electronic apparatus according to the application example, spatial lengths of the sections of the predetermined number may be set to be uniform.

Therefore, the electronic apparatus can present or calculate a variation for each section which is uniform in a space direction.

### Application Example 11

A system according to this application example includes the electronic apparatus according to the application example and the inertial sensor.

Therefore, for example, if the inertial sensor is mounted on, for example, an exercise equipment or a user's body, the electronic apparatus can present or calculate a variation for each section on the basis of output from the inertial sensor. The variation for each section is an index which quantitatively indicates deviation of a plurality of swing trajectories in detail. Therefore, according to the system of the application example, it is possible to objectively estimate reproducibility of a swing.

### Application Example 12

A method according to this application example includes a presentation procedure of dividing each of time-series data items regarding a plurality of swings of an exercise equipment into sections of a predetermined number, and presenting a variation between the time-series data items in the swings for each section.

In the presentation procedure, a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the method of the application example, it is possible to objectively estimate reproducibility of a swing.

### Application Example 13

A method according to this application example includes a calculation procedure of dividing each of time-series data items regarding a plurality of swings into sections of a predetermined number, and calculating a variation between the time-series data items in the swings for each section.

In the calculation procedure, a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the method of the application example, it is possible to objectively estimate reproducibility of a swing.

### Application Example 14

A program according to this application example causes a computer to execute a presentation procedure of dividing each of time-series data items regarding a plurality of swings of an exercise equipment into sections of a predetermined number, and presenting a variation between the time-series data items in the swings for each section.

In the presentation procedure, a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the program of the application example, it is possible to objectively estimate reproducibility of a swing.

### Application Example 15

A program according to this application example causes a computer to execute a calculation procedure of dividing each of time-series data items regarding a plurality of swings of an exercise equipment into sections of a predetermined number, and presenting a variation between the time-series data items in the swings for each section.

In the calculation procedure, a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the program of the application example, it is possible to objectively estimate reproducibility of a swing.

### Application Example 16

A recording medium according to this application example records a program causing a computer to execute a presentation procedure of dividing each of time-series data items regarding a plurality of swings of an exercise equipment into sections of a predetermined number, and presenting a variation between the time-series data items in the swings for each section.

In the presentation procedure, a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the recording medium of the application example, it is possible to objectively estimate reproducibility of a swing.

### Application Example 17

A recording medium according to this application example records a program causing a computer to execute a calculation procedure of dividing each of time-series data items regarding a plurality of swings of an exercise equipment into sections of a predetermined number, and presenting a variation between the time-series data items in the swings for each section.

In the calculation procedure, a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the recording medium of the application example, it is possible to objectively estimate reproducibility of a swing.

### BRIEF DESCRIPTION OF THE DRAWINGS

The invention will be described with reference to the accompanying drawings, wherein like numbers reference like elements.

FIG. 1 is a diagram illustrating a configuration example of a swing diagnosis system of the present embodiment.

FIG. 2 is a diagram illustrating an outline of the swing diagnosis system of the present embodiment.

FIG. 3 is a diagram illustrating examples of a position at which and a direction in which a sensor unit is attached.

FIG. 4 is a diagram illustrating procedures of actions performed by a user until the user hits a ball.

FIG. 5 is a diagram illustrating an example of an input screen of physical information and golf club information.

FIG. 6 is a diagram illustrating a swing action.

FIG. 7 is a diagram illustrating an example of a selection screen.

FIG. 8 illustrates an example of a variation diagnosis screen on which variations in head and grip positions are displayed in a space (back view).

FIG. 9 illustrates an example of a variation diagnosis screen on which variations in head and grip positions are displayed in a space (side view).

FIG. 10 illustrates an example of a variation diagnosis screen on which variations in head and grip positions are displayed in a space (top view).

FIG. 11 illustrates an example of a variation diagnosis screen on which an X axis component of a variation in a head position is displayed in a graph form.

FIG. 12 illustrates an example of a variation diagnosis screen on which a Y axis component of a variation in a head position is displayed in a graph form.

FIG. 13 illustrates an example of a variation diagnosis screen on which a Z axis component of a variation in a head position is displayed in a graph form.

FIG. 14 illustrates an example of a variation diagnosis screen on which an X axis component of a variation in a grip position is displayed in a graph form.

FIG. 15 illustrates an example of a variation diagnosis screen on which a Y axis component of a variation in a grip position is displayed in a graph form.

FIG. 16 illustrates an example of a variation diagnosis screen on which a Z axis component of a variation in a grip position is displayed in a graph form.

FIG. 17 is a diagram illustrating configuration examples of a swing analysis apparatus and a sensor unit of the swing diagnosis system.

FIG. 18 is a diagram illustrating a configuration example of a swing diagnosis apparatus of the swing diagnosis system.

FIG. 19 is a plan view in which a golf club and the sensor unit are viewed from a negative side of an X axis during standing still of the user.

FIG. 20 is a diagram for explaining a relationship between time-series data regarding positions in M swings and N sections (backswing).

FIG. 21 is a diagram for explaining a standard deviation (σ_{Xn}, σ_{Yn}, σ_{Zn}) of an n-th section.

FIG. 22 is a flowchart illustrating examples of procedures of a process of generating swing analysis data in the swing analysis apparatus.

FIG. 23 is a flowchart illustrating examples of procedures of a process of presenting a variation diagnosis screen in the swing analysis apparatus.

FIG. 24 is a flowchart illustrating examples of procedures of a variation diagnosis process performed by the swing diagnosis apparatus.

FIG. 25 is a flowchart illustrating examples of procedures of a variation calculation process performed by the swing diagnosis apparatus.

### DESCRIPTION OF EXEMPLARY EMBODIMENTS

Hereinafter, preferred embodiments of the invention will be described with reference to the drawings. The embodiments described below are not intended to improperly limit the content of the invention disclosed in the appended claims. In addition, all constituent elements described below are not essential constituent elements of the invention.

Hereinafter, a swing analysis system performing analysis of a golf swing will be described as an example.

### 1. First Embodiment

### 1-1. Outline of Swing Diagnosis System

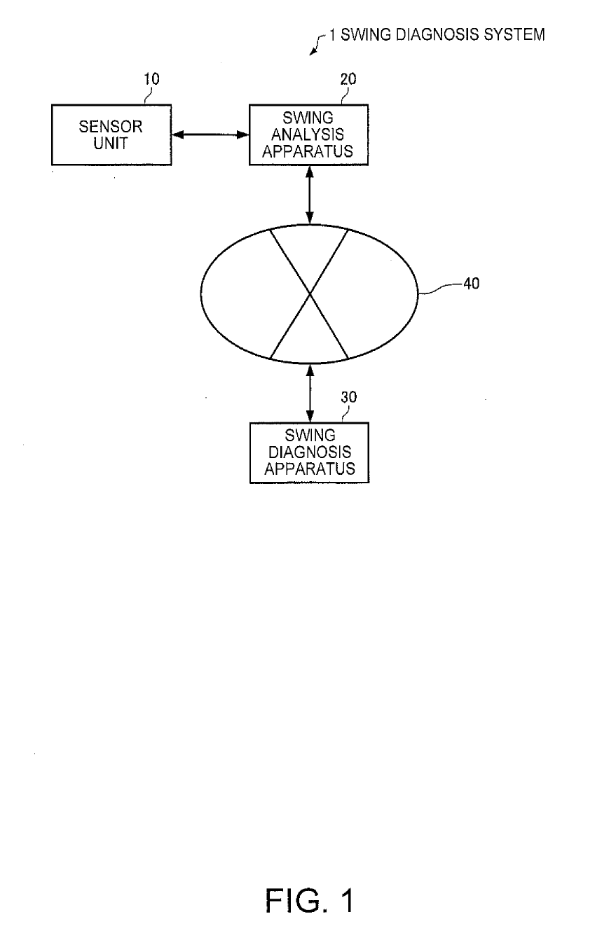

FIG. 1 is a diagram illustrating a configuration example of a swing diagnosis system of the present embodiment. As illustrated in FIG. 1, a swing diagnosis system 1 (an example of a system) of the present embodiment is configured to include a sensor unit 10 (an example of an inertial sensor), a swing analysis apparatus 20 (an example of an electronic apparatus), and a swing diagnosis apparatus 30 (an example of an electronic apparatus).

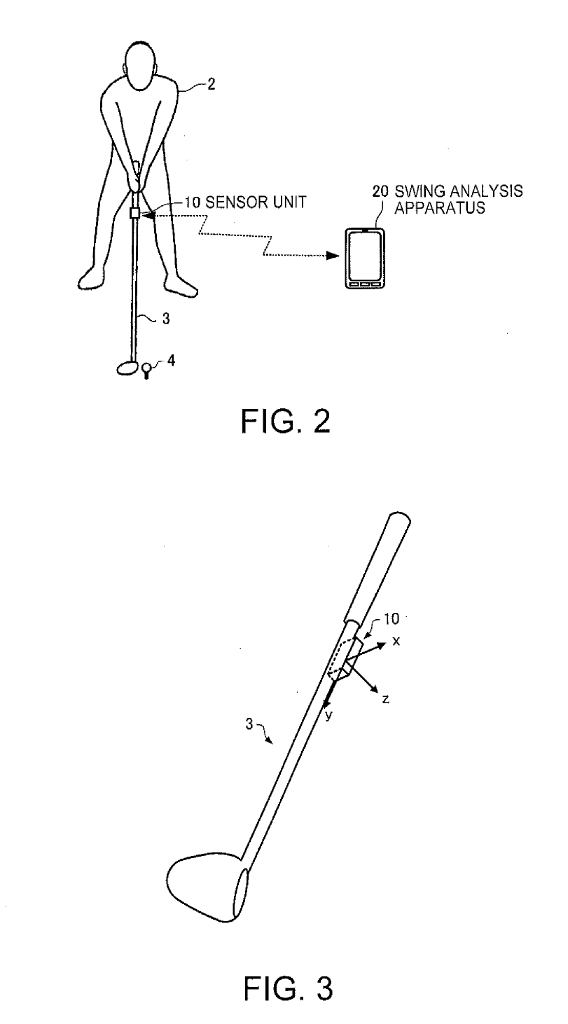

The sensor unit 10 can measure acceleration generated in each axial direction of three axes and angular velocity generated around each of the three axes, and is attached to a golf club 3 (an example of an exercise equipment) as illustrated in FIG. 2.

### 1-2. Attachment Examples of Sensor Unit

As illustrated in FIG. 3, the sensor unit 10 is attached to a part of a shaft so that one axis of three detection axes (an x axis, a y axis, and a z axis), for example, the y axis matches a longitudinal direction of the shaft of the golf club 3 (a longitudinal direction of the golf club 3; hereinafter, referred to as a long axis direction). Preferably, the sensor unit 10 is attached to a position close to a grip to which impact during ball hitting is hardly forwarded and centrifugal force is hardly applied during a swing. The shaft is a shaft portion other than a head of the golf club 3 and also includes the grip. However, the sensor unit 10 may be attached to a part (for example, the hand or a glove) of a user 2, and may be attached to an accessory such as a wristwatch.

### 1-3. User's Actions

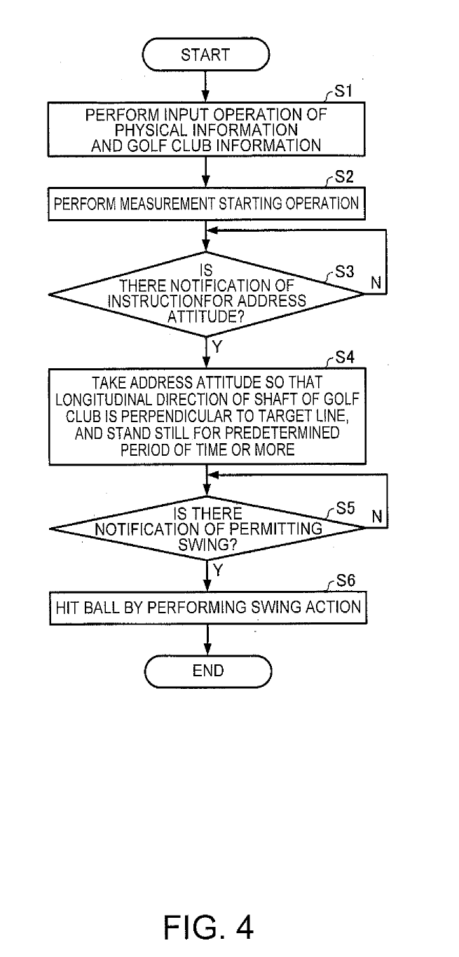

The user 2 performs a swing action for hitting a golf ball 4 according to predefined procedures. FIG. 4 is a diagram illustrating procedures of actions performed by the user 2 until the user hits the ball. As illustrated in FIG. 4, first, the user 2 performs an input operation of physical information of the user 2, information (golf club information) regarding the golf club 3 used by the user 2, and the like via the swing analysis apparatus 20 (S1). The physical information includes at least one of information regarding a height, a length of the arm, and a length of the leg of the user 2, and may further include information regarding a sex or other information. The golf club information includes at least one of information regarding a length (club length) of the golf club 3 and the type (number) of golf club 3. Next, the user 2 performs a measurement starting operation (an operation for starting measurement in the sensor unit 10) via the swing analysis apparatus 20 (S2). Next, after receiving a notification (for example, a notification using a voice) of giving an instruction for taking an address attitude (a basic attitude before starting a swing) from the swing analysis apparatus 20 (Y in S3), the user 2 takes an address attitude so that the axis in the longitudinal direction of the shaft of the golf club 3 is perpendicular to a target line (target hit ball direction), and stands still (S4). Next, the user 2 receives a notification (for example, a notification using a voice) of permitting a swing from the swing analysis apparatus 20 (Y in S5), and then hits the golf ball 4 by performing a swing action (S6).

### 1-4. Input Screen

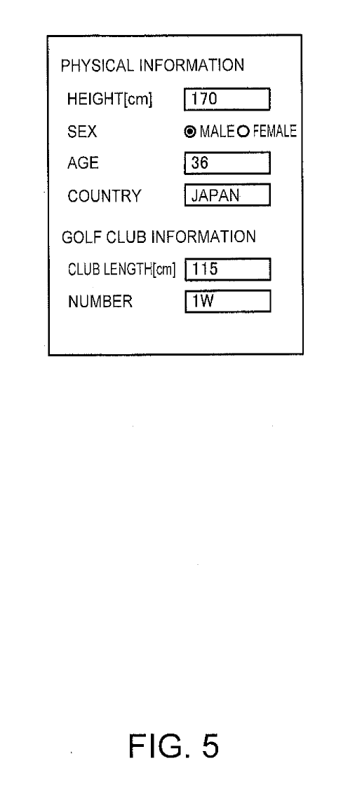

FIG. 5 is a diagram illustrating an example of an input screen of physical information and golf club information, displayed on a display section of the swing analysis apparatus 20. In step S1 in FIG. 4, the user 2 inputs physical information such as a height, a sex, an age, and a country, and inputs golf club information such as a club length (shaft length), and a number on the input screen illustrated in FIG. 5. Information included in the physical information is not limited thereto, and, the physical information may include, for example, at least one of information regarding a length of the arm and a length of the leg instead of or along with the height. Similarly, information included in the golf club information is not limited thereto, and, for example, the golf club information may not include at least one of information regarding the club length and the number, and may include other information.

If the user 2 performs the measurement starting operation in step S2 in FIG. 4, the swing analysis apparatus 20 transmits a measurement starting command to the sensor unit 10, and the sensor unit 10 receives the measurement starting command and starts measurement of three-axis accelerations and three-axis angular velocities. The sensor unit 10 measures three-axis accelerations and three-axis angular velocities in a predetermined sampling cycle Δt (for example, Δt=1 ms), and sequentially transmits the measured data to the swing analysis apparatus 20. Communication between the sensor unit 10 and the swing analysis apparatus 20 may be wireless communication, and may be wired communication.

The swing analysis apparatus 20 notifies the user 2 of permission of swing starting, shown in step S5 in FIG. 4, and then analyzes the swing action (S6 in FIG. 4) in which the user 2 has hit the ball by using the golf club 3 on the basis of measured data from the sensor unit 10.

### 1-5. Swing Action

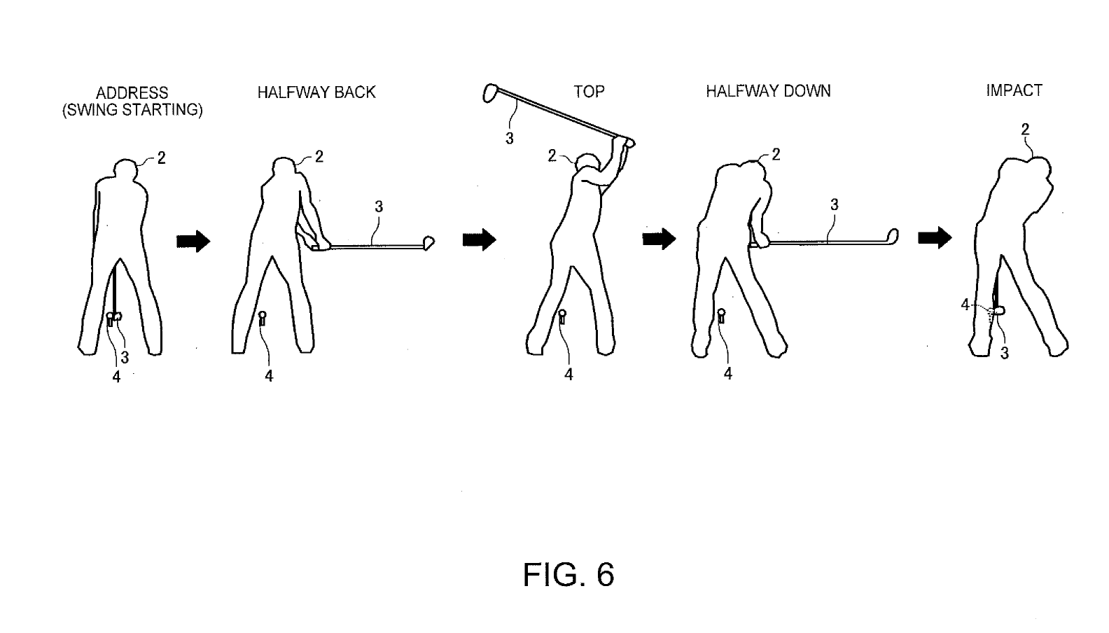

As illustrated in FIG. 6, the swing action performed by the user 2 in step S6 in FIG. 4 includes an action reaching impact (ball hitting) at which the golf ball 4 is hit through respective states of halfway back at which the shaft of the golf club 3 becomes horizontal during a backswing after starting a swing (backswing), a top at which the swing changes from the backswing to a downswing, and halfway down at which the shaft of the golf club 3 becomes horizontal during the downswing. Hereinafter, as appropriate, in the swing, a period from swing starting to the top will be referred to as a “backswing” or a “backswing period”, a period from the top to the impact will be referred to as a “downswing” or a “downswing period”, and a period from swing starting to the impact will be referred to as the “entire swing period” or the “entire swing”.

### 1-6. Selection Screen

The swing analysis apparatus 20 generates swing analysis data including information regarding a time point (date and time) at which the swing is performed, identification information or a sex of the user 2, the type of golf club 3, and an analysis result of the swing action, and transmits the swing analysis data to the swing diagnosis apparatus 30 via a network 40 (refer to FIG. 1).

The swing diagnosis apparatus 30 receives the swing analysis data transmitted by the swing analysis apparatus 20 via the network 40, and preserves the swing analysis data. Therefore, when the user 2 performs a swing action according to the procedures illustrated in FIG. 4, the swing analysis data generated by the swing analysis apparatus 20 is preserved in the swing diagnosis apparatus 30, and thus a swing analysis data list is built in a storage section of the swing diagnosis apparatus 30.

For example, the swing analysis apparatus 20 is implemented by an information terminal (client terminal) such as a smart phone or a personal computer, and the swing diagnosis apparatus 30 is implemented by a server which processes requests from the swing analysis apparatus 20.

The network 40 may be a wide area network (WAN) such as the Internet, and may be a local area network (LAN). The swing analysis apparatus 20 and the swing diagnosis apparatus 30 may communicate with each other through, for example, near field communication or wired communication, without using the network 40.

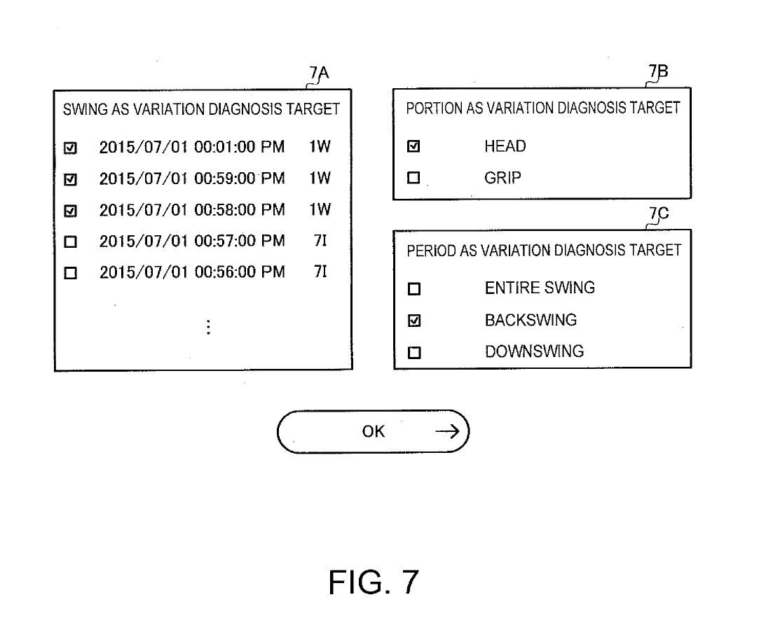

If the user 2 activates a swing diagnosis application via an operation section of the swing analysis apparatus 20, the swing analysis apparatus 20 performs communication with the swing diagnosis apparatus 30, and, for example, a selection screen as illustrated in FIG. 7 is displayed on the display section of the swing analysis apparatus 20.

The selection screen includes a region 7A for allowing the user 2 to select a plurality of swings as a variation diagnosis target which will be described later, a region 7B for allowing the user 2 to select a portion of the golf club as a variation diagnosis target, and a region 7C for allowing the user 2 to select a period as a variation diagnosis target.

Swing candidates are listed in the region 7A. These swing candidates are respective swings for generating a plurality of swing analysis data items preserved in the swing analysis data list. FIG. 7 illustrates an example in which a time point (date and time) of a swing, the type of golf club used for the swing, and the like are displayed instead of a candidate name of the swing. The user 2 may select a plurality of desired swings as variation diagnosis targets from among the plurality of swing candidates.

For example, the user 2 selects a plurality of swings from several months ago, performs variation diagnosis, selects a plurality of latest swings after practice, performs variation diagnosis, and thus can determine whether or not stability of a swing is increased.

Portion candidates of the golf club 3 are listed in the region 7B. In the present embodiment, as the portion candidates, the “head” and the “grip” are assumed to be listed. The user 2 may select one of the “head” and the “grip” as a variation diagnosis target.

Swing period candidates are listed in the region 7C. In the present embodiment, as the period candidates, the “backswing”, the “downswing”, and the “entire swing” are assumed to be listed. The user 2 may select one of the “backswing”, the “downswing”, and the “entire swing” as a variation diagnosis target.

In the regions 7A, 7B and 7C, a checkbox is disposed on the left of each candidate. The user 2 operates an operation section of the swing analysis apparatus 20 so as to switch on a checkbox located on the left of a desired candidate, then presses (selects) an OK button on a lower side of the selection screen, and can thus notify the swing analysis apparatus 20 of the selected content.

The swing analysis apparatus 20 having received the notification performs communication with the swing diagnosis apparatus 30, and transmits selection information indicating the selected content to the swing diagnosis apparatus 30. The swing diagnosis apparatus 30 receives the input information, and performs a variation diagnosis process by using the selection information.

For example, in a case where a selected candidate is the “head”, and a selected period is the “backswing”, the swing diagnosis apparatus 30 generates variation diagnosis information indicating to what extent a position of the head varies during the backswing among a plurality of selected swings.

For example, in a case where selected portions are both of the “head” and the “grip”, the swing diagnosis apparatus 30 generates variation diagnosis information indicating to what extent a position of the head varies during the backswing among a plurality of selected swings and variation diagnosis information to what extent a position of the grip varies during the backswing among the plurality of selected swings. Details of the variation diagnosis information will be described later.

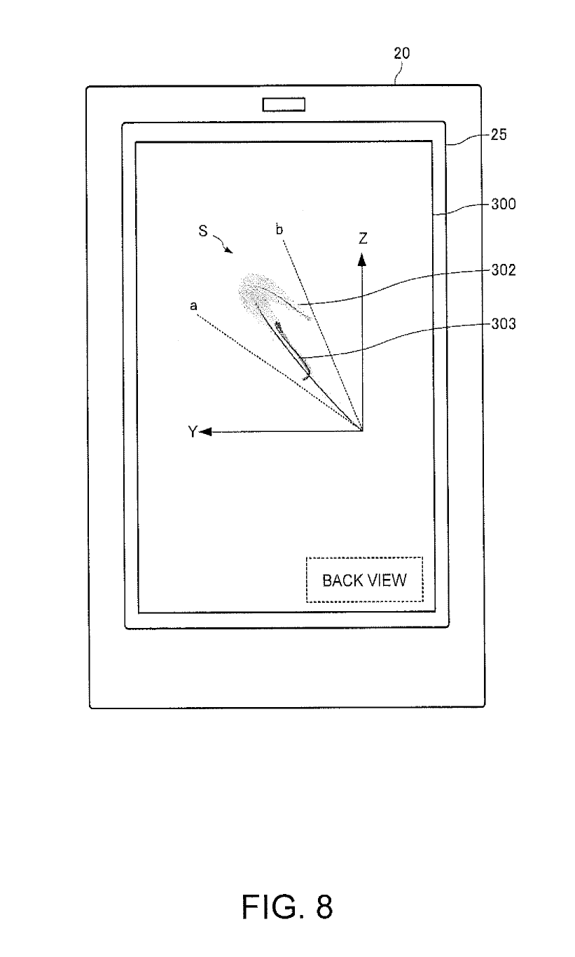

The swing diagnosis apparatus 30 transmits the generated variation diagnosis information to the swing analysis apparatus 20. The swing analysis apparatus 20 receives the variation diagnosis information, and displays a variation diagnosis screen as illustrated in any one of FIGS. 8 to 16 on the display section of the swing analysis apparatus 20 on the basis of the variation diagnosis information.

### 1-7. Variation Diagnosis Screen

FIGS. 8 to 16 illustrate examples of variation diagnosis screens. In the examples illustrated in FIGS. 8 to 16, variation diagnosis information regarding downswings of a plurality of swings selected by the user 2 is displayed under nine display conditions. The “display conditions” mentioned here are combinations of a display viewpoint, a display aspect, and a display target.

Above all, FIGS. 8 to 10 are diagrams in which a variation in a position of the head and a variation in a position of the grip are displayed in a space in different viewpoints.

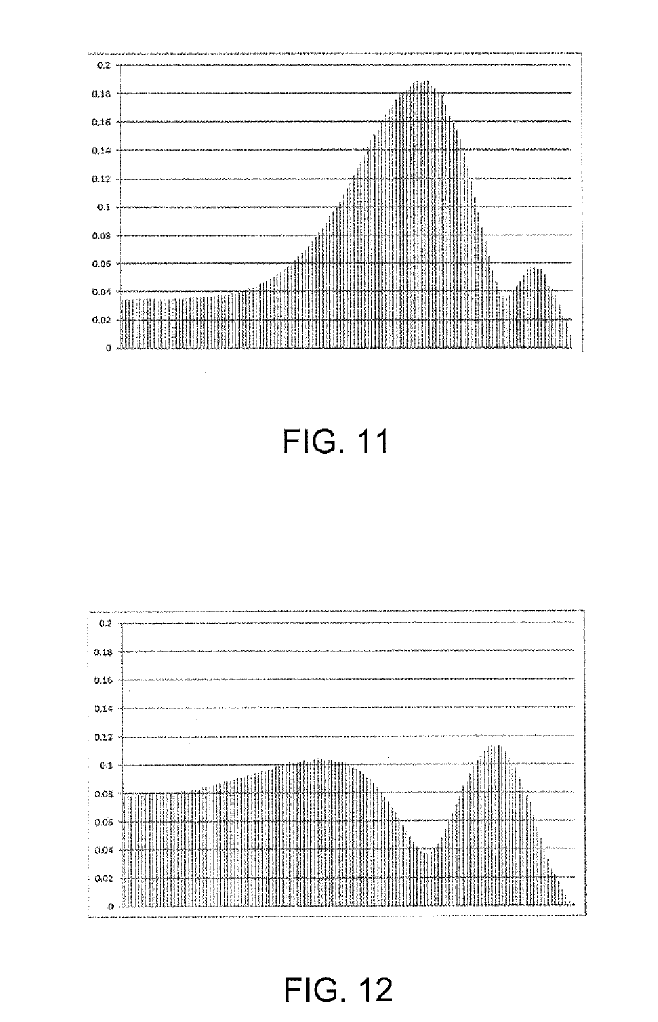

FIGS. 11 to 13 are diagrams in which different components of a variation in a position of the head are displayed in a graph form.

FIGS. 14 to 16 are diagrams in which different components of a variation in a position of the head are displayed in a graph form.

Here, switching between the display conditions is performed, for example, by the user 2 operating the operation section of the swing analysis apparatus 20. In this case, the user 2 may designate a display condition, and display conditions may be switched periodically by the user repeatedly performing a specific operation.

In the examples illustrated in FIGS. 8 to 16, a display target period is used in common (here, the downswing), but display target periods may be switched, and may be displayed on a variation diagnosis screen on which variations for two or more different periods are the same as each other.

Hereinafter, each of FIGS. 8 to 16 will be described.

The variation diagnosis screen illustrated in FIG. 8 includes a strip-shaped image 302 indicating a variation in a position of the head, and a strip-shaped image 303 indicating a variation in a position of the grip. A viewpoint of the variation diagnosis screen illustrated in FIG. 8 is set to the reverse target side (a negative side of the X axis) of the user 2. In the variation diagnosis screen illustrated in FIG. 8, each width of the strip-shaped images 302 and 303 indicates an X axis component of a variation (a standard deviation σ_{X} which will be described later). Information (for example, a text image such as “back view”) indicating the viewpoint is also added to the diagnosis screen illustrated in FIG. 8. A curve image corresponding to a variation center (average values (avr_{X}, avr_{Y}, avr_{Z}) which will be described later) is also drawn in FIG. 8.

Therefore, the user 2 can specify a very unstable portion in a swing of the user on the basis of a portion whose width is considerably increased in the displayed strip-shaped images 302 and 303, and can thus recognize instability in the X axis direction of the portion on the basis of the magnitude of the width.

Along with the images indicating a variation in a position of the head, as illustrated in FIG. 8, a predetermined region S indicating an address attitude of the user 2 may be displayed on the variation diagnosis screen.

The predetermined region S is a region interposed between a first plane a along the longitudinal direction of the golf club 3 and a second plane b passing through the vicinity of the shoulder of the user 2.

The first plane a is, for example, a so-called shaft plane specified by a first axis along a target hit ball direction and a second axis along the longitudinal direction of the golf club 3 before a swing is started. The second plane b is, for example, a so-called Hogan plane including the first axis and forming a predetermined angle with the first plane a. Although not illustrated in FIG. 8, the second plane b may be a so-called shoulder plane parallel to the first plane a.

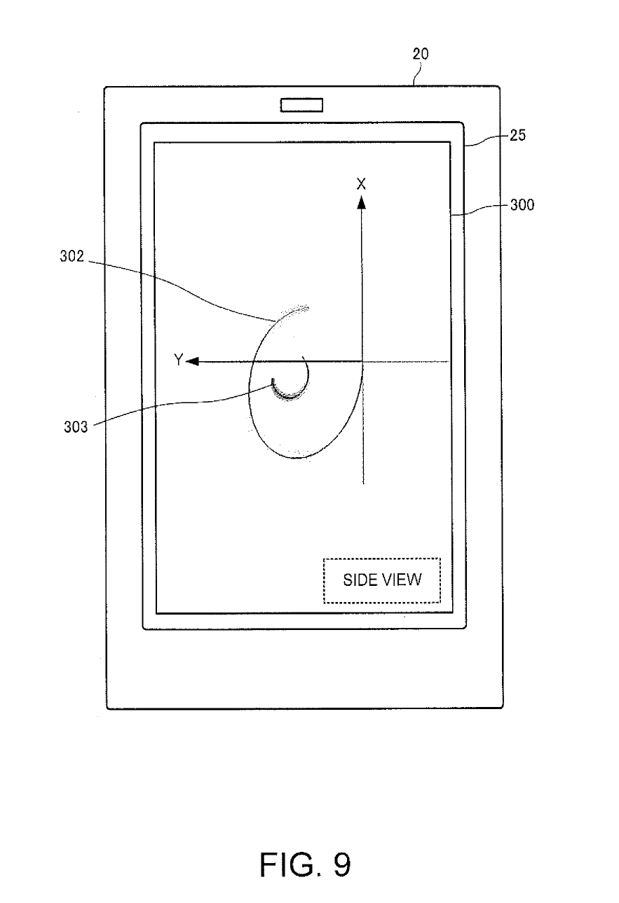

The variation diagnosis screen illustrated in FIG. 9 includes a strip-shaped image 302 indicating a variation in a position of the head, and a strip-shaped image 303 indicating a variation in a position of the grip. A viewpoint of the variation diagnosis screen illustrated in FIG. 9 is set to the front side (a negative side of the Y axis) of the user 2. In the variation diagnosis screen illustrated in FIG. 9, each width of the strip-shaped images 302 and 303 indicates a Y axis component of a variation (a standard deviation σ_{Y} which will be described later). Information (for example, a text image such as “side view”) indicating the viewpoint is also added to the diagnosis screen illustrated in FIG. 9. A curve image corresponding to a variation center (average values (avr_{X}, avr_{Y}, avr_{Z}) which will be described later) is also drawn in FIG. 9.

Therefore, the user 2 can specify a very unstable portion in a swing of the user on the basis of a portion whose width is considerably increased in the displayed strip-shaped images 302 and 303, and can thus recognize instability in the Y axis direction of the portion on the basis of the magnitude of the width.

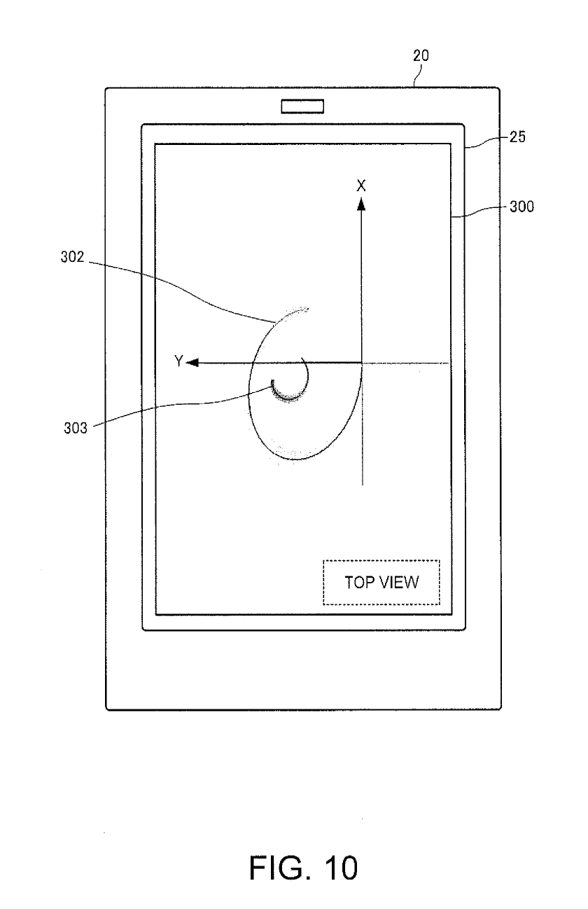

The variation diagnosis screen illustrated in FIG. 10 includes a strip-shaped image 302 indicating a variation in a position of the head, and a strip-shaped image 303 indicating a variation in a position of the grip. A viewpoint of the variation diagnosis screen illustrated in FIG. 10 is set to the top side (a positive side of the Z axis) of the user 2. In the variation diagnosis screen illustrated in FIG. 10, each width of the strip-shaped images 302 and 303 indicates a Z axis component of a variation (a standard deviation σ_{Z} which will be described later). Information (for example, a text image such as “top view”) indicating the viewpoint is also added to the diagnosis screen illustrated in FIG. 10. A curve image corresponding to a variation center (average values (avr_{X}, avr_{Y}, avr_{Z}) which will be described later) is also drawn in FIG. 10.

Therefore, the user 2 can specify a very unstable portion in a swing of the user on the basis of a portion whose width is considerably increased in the displayed strip-shaped images 302 and 303, and can thus recognize instability in the Z axis direction of the portion on the basis of the magnitude of the width.

In the variation diagnosis screens illustrated in FIGS. 8, 9 and 10, marks such as dot marks may be further plotted at head positions and grip positions at respective tops of a plurality of swings. In this case, the user 2 can check the extent of variations in top positions among the plurality of swings on the basis of a distribution of the plotted positions of the plurality of marks.

The variation diagnosis screens illustrated in FIGS. 8, 9 and 10 are examples in which the respective components of a variation of a section are spatially displayed on the different screens, but a variation (σ_{X}, σ_{Y}, σ_{Z}) formed of three components may be spatially displayed on the same screen. In this case, for example, elliptical images (each of which is an elliptical polygon having σ_{X} as a width in the X axis direction, σ_{Y} as a width in the Y axis direction, and σ_{Z} as a width in the Z axis direction) indicating a variation (σ_{X}, σ_{Y}, σ_{Z}) of a certain section may be arranged at positions corresponding to the section in the screen, and thus the variation of the section may be stereoscopically expressed. Here, the elliptical image is used, but a rectangular parallelepiped image may be used instead of the elliptical image.

Alternatively, spherical images (each of which is an spherical polygon having an average value of σ_{X}, σ_{Y}, and σ_{Z} as widths in the X axis direction, the Y axis direction, and the Z axis direction) indicating a variation (σ_{X}, σ_{Y}, σ_{Z}) of a certain section may be arranged at positions corresponding to the section in the screen, and thus the variation of the section may be stereoscopically expressed. Here, the spherical image is used, but a cubic image may be used instead of the spherical image.

The variation diagnosis screen illustrated in FIG. 11 includes a bar graph indicating a variation in a position of the head for each section (FIG. 11 illustrates a state of a screen inside). A transverse axis of the graphs illustrated in FIG. 11 is a time axis (a section number which will be described later), and a longitudinal axis (unit: meter) expresses a variation (a standard deviation σ_{X} which will be described later) in the X axis direction.

The variation diagnosis screen illustrated in FIG. 12 includes a bar graph indicating a variation in a position of the head for each section (FIG. 12 illustrates a state of a screen inside). A transverse axis of the graphs illustrated in FIG. 12 is a time axis (a section number which will be described later), and a longitudinal axis (unit: meter) expresses a variation (a standard deviation σ_{Y} which will be described later) in the Y axis direction.

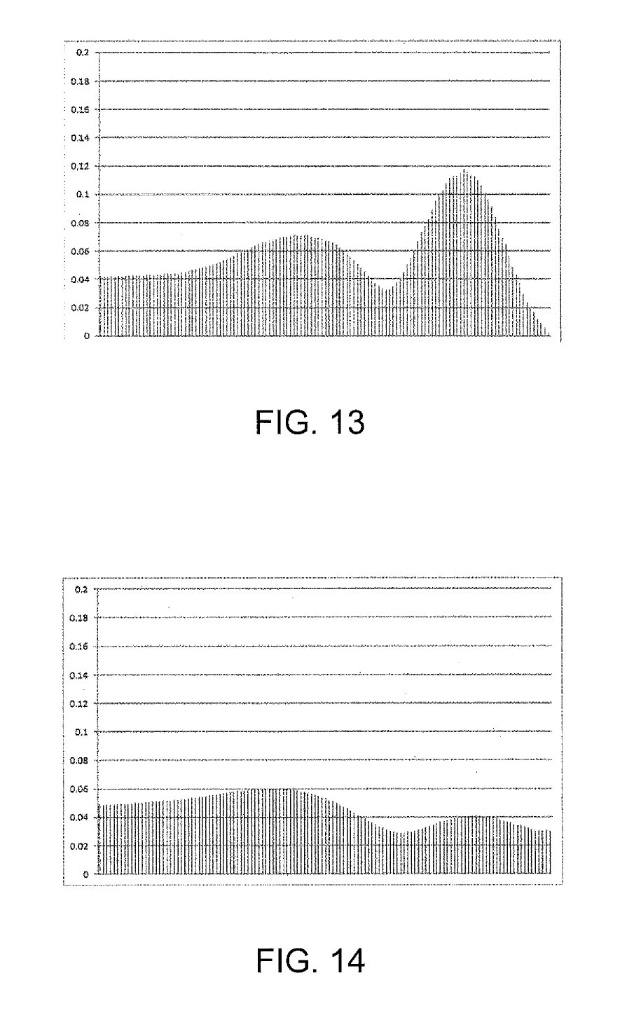

The variation diagnosis screen illustrated in FIG. 13 includes a bar graph indicating a variation in a position of the head for each section (FIG. 13 illustrates a state of a screen inside). A transverse axis of the graphs illustrated in FIG. 13 is a time axis (a section number which will be described later), and a longitudinal axis (unit: meter) expresses a variation (a standard deviation σ_{Z} which will be described later) in the Z axis direction.

The variation diagnosis screen illustrated in FIG. 14 includes a bar graph indicating a variation in a position of the grip for each section (FIG. 14 illustrates a state of a screen inside). A transverse axis of the graphs illustrated in FIG. 14 is a time axis (a section number which will be described later), and a longitudinal axis (unit: meter) expresses a variation (a standard deviation σ_{X} which will be described later) in the X axis direction.

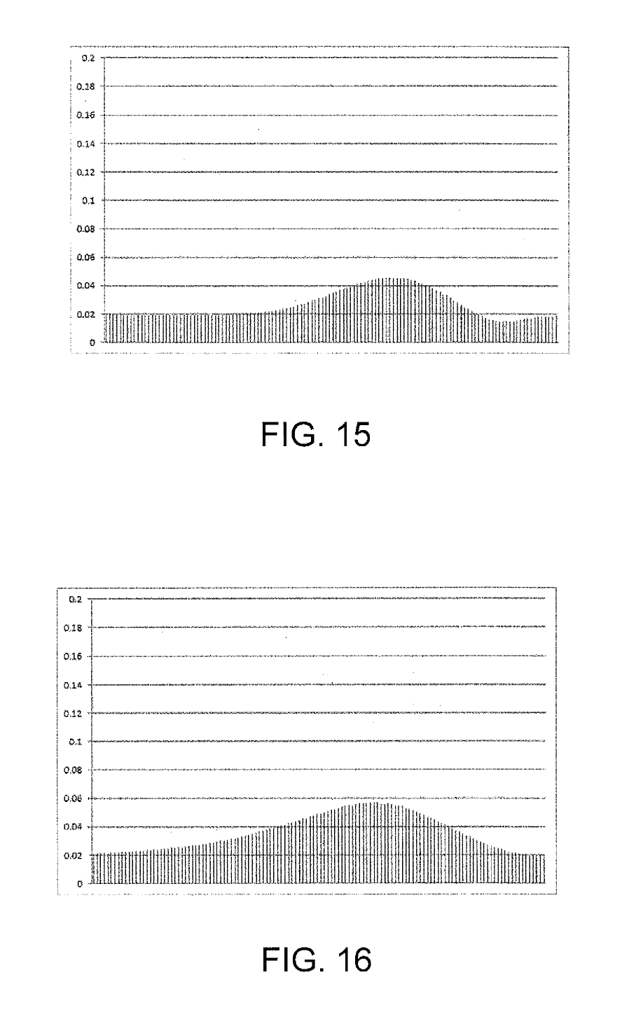

The variation diagnosis screen illustrated in FIG. 15 includes a bar graph indicating a variation in a position of the grip for each section (FIG. 15 illustrates a state of a screen inside). A transverse axis of the graphs illustrated in FIG. 15 is a time axis (a section number which will be described later), and a longitudinal axis (unit: meter) expresses a variation (a standard deviation σ_{Y} which will be described later) in the Y axis direction.

The variation diagnosis screen illustrated in FIG. 16 includes a bar graph indicating a variation in a position of the grip for each section (FIG. 16 illustrates a state of a screen inside). A transverse axis of the graphs illustrated in FIG. 16 is a time axis (a section number which will be described later), and a longitudinal axis (unit: meter) expresses a variation (a standard deviation σ_{Z} which will be described later) in the Z axis direction.

### 1-8. Configuration of Swing Analysis System

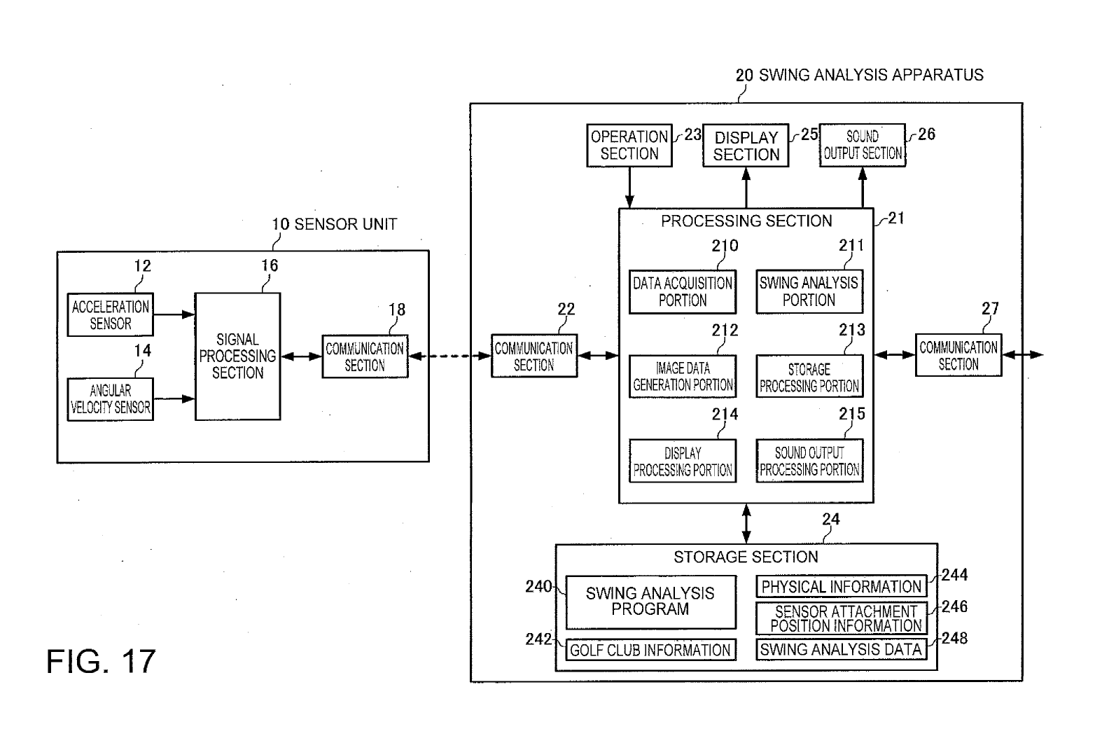

FIG. 17 is a diagram illustrating configuration examples of the sensor unit 10 and the swing analysis apparatus 20. As illustrated in FIG. 17, in the present embodiment, the sensor unit 10 is configured to include an acceleration sensor 12, an angular velocity sensor 14, a signal processing section 16, and a communication section 18. However, the sensor unit 10 may have a configuration in which some of the constituent elements are deleted or changed as appropriate, or may have a configuration in which other constituent elements are added thereto.

The acceleration sensor 12 measures respective accelerations in three axial directions which intersect (ideally, orthogonal to) each other, and outputs digital signals (acceleration data) corresponding to magnitudes and directions of the measured three-axis accelerations.

The angular velocity sensor 14 measures respective angular velocities in three axial directions which intersect (ideally, orthogonal to) each other, and outputs digital signals (angular velocity data) corresponding to magnitudes and directions of the measured three-axis angular velocities.

The signal processing section 16 receives the acceleration data and the angular velocity data from the acceleration sensor 12 and the angular velocity sensor 14, respectively, stores the data in a storage portion (not illustrated), adds time information to the stored measured data (acceleration data and angular velocity data) so as to generate packet data conforming to a communication format, and outputs the packet data to the communication section 18.

Ideally, the acceleration sensor 12 and the angular velocity sensor 14 are provided in the sensor unit 10 so that the three axes thereof match three axes (an x axis, a y axis, and a z axis) of an orthogonal coordinate system (sensor coordinate system) defined for the sensor unit 10, but, actually, errors occur in installation angles. Therefore, the signal processing section 16 performs a process of converting the acceleration data and the angular velocity data into data in the xyz coordinate system by using a correction parameter which is calculated in advance according to the installation angle errors.

The signal processing section 16 may perform a process of correcting the temperatures of the acceleration sensor 12 and the angular velocity sensor 14. The acceleration sensor 12 and the angular velocity sensor 14 may have a temperature correction function.

The acceleration sensor 12 and the angular velocity sensor 14 may output analog signals, and, in this case, the signal processing section 16 may A/D convert an output signal from the acceleration sensor 12 and an output signal from the angular velocity sensor 14 so as to generate measured data (acceleration data and angular velocity data), and may generate communication packet data by using the data.

The communication section 18 performs a process of transmitting packet data received from the signal processing section 16 to the swing analysis apparatus 20, or a process of receiving various control commands such as a measurement starting command from the swing analysis apparatus 20 and sending the control command to the signal processing section 16. The signal processing section 16 performs various processes corresponding to control commands.

As illustrated in FIG. 17, in the present embodiment, the swing analysis apparatus 20 is configured to include a processing section 21 (an example of a computer), a communication section 22, an operation section 23, a storage section 24, a display section 25 (an example of a presentation portion), a sound output section 26 (an example of a presentation portion), and a communication section 27. However, the swing analysis apparatus 20 may have a configuration in which some of the constituent elements are deleted or changed as appropriate, or may have a configuration in which other constituent elements are added thereto.

The communication section 22 performs a process of receiving packet data transmitted from the sensor unit 10 and sending the packet data to the processing section 21, or a process of transmitting a control command from the processing section 21 to the sensor unit 10.

The operation section 23 performs a process of acquiring operation data from the user 2 and sending the operation data to the processing section 21. The operation section 23 may be, for example, a touch panel type display, a button, a key, or a microphone.

The storage section 24 is constituted of, for example, various IC memories such as a read only memory (ROM), a flash ROM, and a random access memory (RAM), or a recording medium such as a hard disk or a memory card. The storage section 24 stores a program for the processing section 21 performing various calculation processes or a control process, or various programs or data for realizing application functions.

In the present embodiment, the storage section 24 stores a swing analysis program 240 (an example of a program) which is read by the processing section 21. The swing analysis program 240 may be stored in a nonvolatile recording medium (computer readable recording medium) in advance, or the swing analysis program 240 may be received from a server (not illustrated) or the swing diagnosis apparatus 30 by the processing section 21 via a network, and may be stored in the storage section 24.

In the present embodiment, the storage section 24 stores golf club information 242, physical information 244, sensor attachment position information 246, and swing analysis data 248. For example, the user 2 may operate the operation section 23 so as to input specification information regarding the golf club 3 to be used (for example, at least some information such as information regarding a length of the shaft, a position of the centroid thereof, a lie angle, a face angle, a loft angle, and the like) from the input screen illustrated in FIG. 5, and the input specification information may be used as the golf club information 242. Alternatively, in step S1 in FIG. 4, the user 2 may input type numbers of the golf club 3 (alternatively, selects a type number from a type number list) and specification information of an input type number among specification information for each type number is stored in the storage section 24 in advance may be used as the golf club information 242.

For example, the user 2 may input physical information by operating the operation section 23 from the input screen illustrated in FIG. 5, and the input physical information may be used as the physical information 244. For example, in step S1 in FIG. 4, the user 2 may input a distance between an attachment position of the sensor unit 10 and the grip end of the golf club 3 by operating the operation section 23, and the input distance information may be used as the sensor attachment position information 246. Alternatively, the sensor unit 10 may be attached at a defined predetermined position (for example, a distance of 20 cm from the grip), and thus information regarding the predetermined position may be stored as the sensor attachment position information 246 in advance.

The swing analysis data 248 is data including information regarding a swing action analysis result in the processing section 21 (swing analysis portion 211) along with a time point (date and time) at which a swing was performed, identification information or a sex of the user 2, and the type of golf club 3.

The storage section 24 is used as a work area of the processing section 21, and temporarily stores data which is input from the operation section 23, results of calculation executed by the processing section 21 according to various programs, and the like. The storage section 24 may store data which is required to be preserved for a long period of time among data items generated through processing in the processing section 21.

The display section 25 displays a processing result in the processing section 21 as text, a graph, a table, animation, and other images. The display section 25 may be, for example, a CRT, an LCD, a touch panel type display, and a head mounted display (HMD). A single touch panel type display may realize functions of the operation section 23 and the display section 25.

The sound output section 26 outputs a processing result in the processing section 21 as a sound such as a voice or a buzzer sound. The sound output section 26 may be, for example, a speaker or a buzzer.

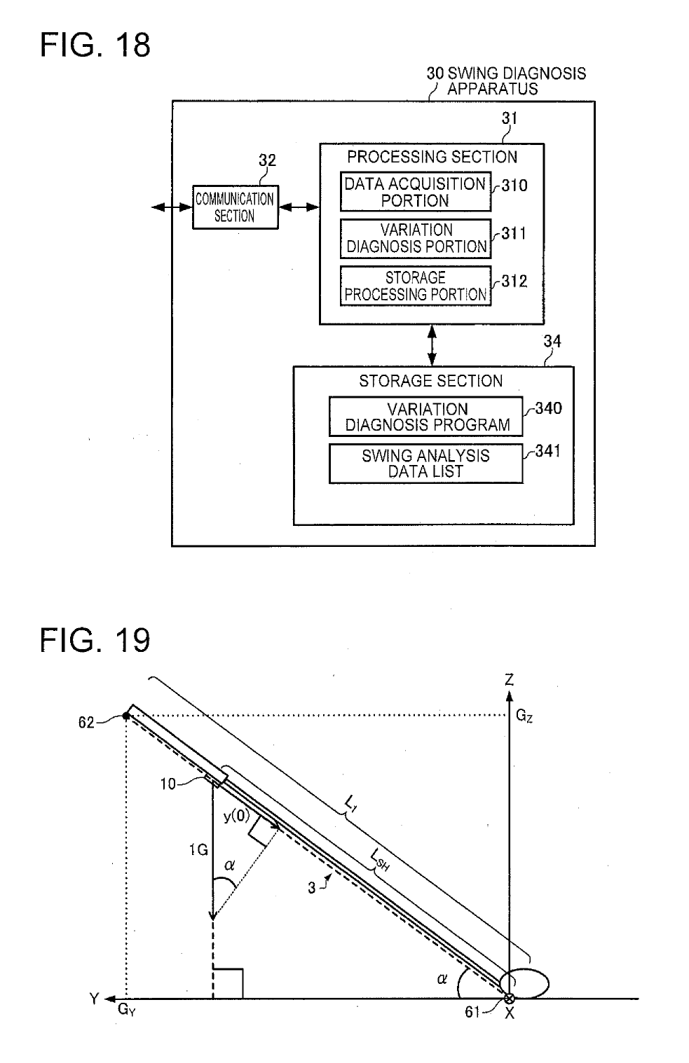

The communication section 27 performs data communication with a communication section 32 (refer to FIG. 18) of the swing diagnosis apparatus 30 via the network 40. For example, the communication section 27 performs a process of receiving the swing analysis data 248 from the processing section 21 after a swing analysis data generation process is completed, and transmitting the swing analysis data to the communication section 32 of the swing diagnosis apparatus 30. For example, the communication section 27 performs a process of receiving information required to display the selection screen illustrated in FIG. 7 from the communication section 32 of the swing diagnosis apparatus 30 and transmitting the information to the processing section 21, and a process of receiving selection information indicating the content selected by the user 2 on the selection screen illustrated in FIG. 7 from the processing section 21 and transmitting the selection information to the communication section 32 of the swing diagnosis apparatus 30. For example, the communication section 27 performs a process of receiving information (variation diagnosis information) required to display a variation diagnosis screen (refer to FIGS. 8 to 16) from the communication section 32 of the swing diagnosis apparatus 30, and transmitting the information to the processing section 21.

The processing section 21 performs a process of transmitting a control command to the sensor unit 10 via the communication section 22, or various computation processes on data which is received from the sensor unit 10 via the communication section 22, according to various programs. The processing section 21 performs a process of reading the swing analysis data 248 from the storage section 24, and transmitting the swing analysis data to the swing diagnosis apparatus 30 via the communication section 27, according to various programs. The processing section 21 performs a process of transmitting various pieces of information to the swing diagnosis apparatus 30 via the communication section 27, and displaying various screens on the basis of the information received from the swing diagnosis apparatus 30, according to various programs. The processing section 21 performs other various control processes.

Particularly, in the present embodiment, by executing the swing analysis program 240, the processing section 21 functions as a data acquisition portion 210, a swing analysis portion 211, an image data generation portion 212, a storage processing portion 213, a display processing portion 214, and a sound output processing portion 215, and performs a swing analysis data generation process and a variation diagnosis screen presentation process. Details of the swing analysis data generation process and the variation diagnosis screen presentation process will be described later.

The data acquisition portion 210 performs a process of receiving packet data which is received from the sensor unit 10 by the communication section 22, acquiring time information and measured data in the sensor unit 10 from the received packet data, and sending the time information and the measured data to the storage processing portion 213. The data acquisition portion 210 performs a process of receiving the information required to display the various screens, received from the swing diagnosis apparatus 30 by the communication section 27, and transmitting the information to the image data generation portion 212.

The storage processing portion 213 performs read/write processes of various programs or various data for the storage section 24. The storage processing portion 213 performs not only the process of storing the time information and the measured data received from the data acquisition portion 210 in the storage section 24 in correlation with each other, but also a process of storing various pieces of information calculated by the swing analysis portion 211, the swing analysis data 248, or the like in the storage section 24.

The swing analysis portion 211 performs a process of analyzing a swing action of the user 2 by using the measured data (the measured data stored in the storage section 24) output from the sensor unit 10, the data from the operation section 23, or the like, so as to generate the swing analysis data 248 including a time point (date and time) at which the swing was performed, identification information or a sex of the user 2, the type of golf club 3, and information regarding a swing action analysis result. Particularly, in the present embodiment, the swing analysis portion 211 calculates time-series data regarding positions of each portion (for example, the head or the grip) of the golf club 3 as at least some of the information regarding the swing action analysis result. The swing analysis portion 211 detects each timing (for example, a swing starting timing, a top timing, or an impact timing) in the time-series data as at least some of the information regarding the swing action analysis result. Details of calculation of the time-series data regarding positions and detection of each timing will be described later.

The swing analysis portion 211 may not calculate values of some of the indexes, and may calculate values of other indexes, as appropriate.

The image data generation portion 212 performs a process of generating image data corresponding to an image displayed on the display section 25. For example, the image data generation portion 212 generates image data corresponding to the selection screen illustrated in FIG. 7, and the variation diagnosis screens illustrated in FIGS. 8 to 16 on the basis of various pieces of information received by the data acquisition portion 210.

The display processing portion 214 performs a process of displaying various images (including text, symbols, and the like in addition to an image corresponding to the image data generated by the image data generation portion 212) on the display section 25. For example, the display processing portion 214 displays the selection screen illustrated in FIG. 7 and the variation diagnosis screens illustrated in FIGS. 8 to 16 on the display section 25 on the basis of the image data generated by the image data generation portion 212. For example, the image data generation portion 212 may display an image, text, or the like for notifying the user 2 of permission of swing starting on the display section 25 in step S5 in FIG. 4. For example, the display processing portion 214 may display text information such as text or symbols indicating an analysis result in the swing analysis portion 211 on the display section 25 automatically or in response to an input operation performed by the user 2 after a swing action of the user 2 is completed. Alternatively, a display section may be provided in the sensor unit 10, and the display processing portion 214 may transmit image data to the sensor unit 10 via the communication section 22, and various images, text, or the like may be displayed on the display section of the sensor unit 10.

The sound output processing portion 215 performs a process of outputting various sounds (including voices, buzzer sounds, and the like) from the sound output section 26. For example, the sound output processing portion 215 may output a sound for notifying the user 2 of permission of swing starting from the sound output section 26 in step S5 in FIG. 4. For example, the sound output processing portion 215 may output a sound or a voice indicating an analysis result in the swing analysis portion 211 from the sound output section 26 automatically or in response to an input operation performed by the user 2 after a swing action of the user 2 is completed. Alternatively, a sound output section may be provided in the sensor unit 10, and the sound output processing portion 215 may transmit various items of sound data or voice data to the sensor unit 10 via the communication section 22, and may output various sounds or voices from the sound output section of the sensor unit 10.

A vibration mechanism may be provided in the swing analysis apparatus 20 or the sensor unit 10, and various pieces of information may be converted into pieces of vibration information by the vibration mechanism so as to be presented to the user 2.

FIG. 18 is a diagram illustrating a configuration example of the swing diagnosis apparatus 30. As illustrated in FIG. 18, in the present embodiment, the swing diagnosis apparatus 30 is configured to include a processing section 31 (an example of a computer), the communication section 32, and a storage section 34. However, the swing diagnosis apparatus 30 may have a configuration in which some of the constituent elements are deleted or changed as appropriate, or may have a configuration in which other constituent elements are added thereto.

The storage section 34 is constituted of, for example, various IC memories such as a ROM, a flash ROM, and a RAM, or a recording medium such as a hard disk or a memory card. The storage section 34 stores a program for the processing section 31 performing various calculation processes or a control process, or various programs or data for realizing application functions.

In the present embodiment, the storage section 34 stores a variation diagnosis program 340 which is read by the processing section 31 and executes a variation diagnosis process. The variation diagnosis program 340 may be stored in a nonvolatile recording medium (computer readable recording medium) in advance, or the variation diagnosis program 340 may be received from a server (not illustrated) or the swing diagnosis apparatus 30 by the processing section 31 via a network, and may be stored in the storage section 34.

In the present embodiment, the storage section 34 stores (preserves) a swing analysis data list 341 including a plurality of items of swing analysis data 248 generated by the swing analysis apparatus 20. In other words, the swing analysis data 248 generated whenever the processing section 21 of the swing analysis apparatus 20 analyzes a swing action of the user 2 is sequentially added to the swing analysis data list 341.

The storage section 34 is used as a work area of the processing section 31, and temporarily stores results of calculation executed by the processing section 31 according to various programs, and the like. The storage section 34 may store data which is required to be preserved for a long period of time among data items generated through processing of the processing section 31.

The communication section 32 performs data communication with the communication section 27 (refer to FIG. 17) of the swing analysis apparatus 20 via the network 40. For example, the communication section 32 performs a process of receiving the swing analysis data 248 from the communication section 27 of the swing analysis apparatus 20, and transmitting the swing analysis data 248 to the processing section 31. For example, the communication section 32 performs a process of transmitting information required to display the selection screen illustrated in FIG. 7 to the communication section 27 of the swing analysis apparatus 20, or a process of receiving selection information indicating the content selected by the user 2 on the selection screen illustrated in FIG. 7 from the communication section 27 of the swing analysis apparatus 20 and transmitting the selection information to the processing section 31. For example, the communication section 32 performs a process of receiving variation diagnosis information required to display the variation diagnosis screens (FIGS. 8 to 16) from the processing section 31, and transmitting the information to the communication section 27 of the swing analysis apparatus 20.

The processing section 31 performs a process of receiving the swing analysis data 248 from the swing analysis apparatus 20 via the communication section 32 and storing the swing analysis data 248 in the storage section 34 (adding the swing analysis data to the swing analysis data list 341), according to various programs. The processing section 31 performs a process of receiving various pieces of information from the swing analysis apparatus 20 via the communication section 32, and transmitting information required to display various screens to the swing analysis apparatus 20 according to various programs. The processing section 31 performs other various control processes.

Particularly, in the present embodiment, the processing section 31 functions as a data acquisition portion 310, a variation diagnosis portion 311 (an example of a calculation portion), and a storage processing portion 312 by executing the swing diagnosis program 340, and performs a variation diagnosis process based on the selection information. Details of the variation diagnosis process will be described later.

The data acquisition portion 310 performs a process of receiving the swing analysis data 248 received from the swing analysis apparatus 20 by the communication section 32 and transmitting the swing analysis data 248 to the storage processing portion 312. The data acquisition portion 310 performs a process of receiving various pieces of information (in the present embodiment, the above-described selection information and the like) received from the swing analysis apparatus 20 by the communication section 32 and transmitting the information to the variation diagnosis portion 311.

The storage processing portion 312 performs read/write processes of various programs or various data for the storage section 34. The storage processing portion 312 performs a process of receiving the swing analysis data 248 from the data acquisition portion 310 and storing the swing analysis data 248 in the storage section 34 (adding the swing analysis data to the swing analysis data list 341), a process of reading the swing analysis data 248 from the swing analysis data list 341 stored in the storage section 34, or the like.

The variation diagnosis portion 311 performs a variation diagnosis process on the basis of data regarding a swing. Among a plurality of swing analysis data items included in the swing analysis data list 341, a plurality of swing analysis data items regarding a plurality of swings selected by the user 2 are used for the variation diagnosis process of the present embodiment.

### 1-9. Setting of Global Coordinate System

The swing analysis portion 211 of the swing analysis apparatus 20 sets a global coordinate system, for example, as follows.

As illustrated in FIG. 19, when a position of the head of the golf club 3 at address (during standing still) is set to the origin, the global coordinate system is an XYZ coordinate system which has a target line indicating a target hit ball direction as an X axis, an axis on a horizontal plane which is perpendicular to the X axis as a Y axis, and a vertically upward direction (a direction opposite to the gravitational acceleration direction) as a Z axis. The swing analysis portion 211 calculates a position and an attitude of the sensor unit 10 in a time series from the time of the address in the XYZ coordinate system (global coordinate system) by using measured data (acceleration data and angular velocity data) in the sensor unit 10.

### 1-10. Calculation of Time-Series Data Regarding Positions

The swing analysis portion 211 of the swing analysis apparatus 20 calculates time-series data regarding positions of each portion of the golf club 3, for example, as follows.

If the user 2 performs the action in step S4 in FIG. 4, first, the swing analysis portion 211 of the swing analysis apparatus 20 determines that the user 2 stands still at an address attitude in a case where an amount of changes in acceleration data measured by the acceleration sensor 12 does not continuously exceed a threshold value for a predetermined period of time. Next, the swing analysis portion 211 computes an offset amount included in the measured data by using the measured data (acceleration data and angular velocity data) for the predetermined period of time. Next, the swing analysis portion 211 subtracts the offset amount from the measured data so as to perform bias correction, and computes a position and an attitude of the sensor unit 10 during a swing action of the user 2 (during the action in step S6 in FIG. 4) by using the bias-corrected measured data.

Specifically, first, the swing analysis portion 211 computes a position (initial position) of the sensor unit 10 during standing still (at address) of the user 2 in the XYZ coordinate system (global coordinate system) by using the acceleration data measured by the acceleration sensor 12, the golf club information 242, and the sensor attachment position information 246.

FIG. 19 is a plan view in which the golf club 3 and the sensor unit 10 during standing still (at address) of the user 2 are viewed from a negative side of the X axis. The origin O (0, 0, 0) is set at a position 61 of the head of the golf club 3, and coordinates of a position 62 of a grip end are (0, G_{Y}, G_{Z}). Since the user 2 performs the action in step S4 in FIG. 4, the position 62 of the grip end or the initial position of the sensor unit 10 has an X coordinate of 0, and is present on a YZ plane. As illustrated in FIG. 19, the gravitational acceleration of 1 G is applied to the sensor unit 10 during standing still of the user 2, and thus a relationship between a y axis acceleration y(0) measured by the sensor unit 10 and an inclined angle (an angle formed between the long axis of the shaft and the horizontal plane (XY plane)) a of the shaft of the golf club 3 is expressed by Equation (1).

y(0)=1G·sin α (1)

Therefore, the swing analysis portion 211 can calculate the inclined angle α according to Equation (1) by using any acceleration data between any time points at address (during standing still).

Next, the swing analysis portion 211 subtracts a distance L_{SG} between the sensor unit 10 and the grip end included in the sensor attachment position information 246 from a length L₁ of the shaft included in the golf club information 242, so as to obtain a distance L_{SH} between the sensor unit 10 and the head. The swing analysis portion 211 sets, as the initial position of the sensor unit 10, a position separated by the distance L_{SH} from the position 61 (origin O) of the head in a direction (a negative direction of the y axis of the sensor unit 10) specified by the inclined angle α of the shaft.

The swing analysis portion 211 integrates subsequent acceleration data so as to compute coordinates of a position from the initial position of the sensor unit 10 in a time series.

The swing analysis portion 211 computes an attitude (initial attitude) of the sensor unit 10 during standing still (at address) of the user 2 in the XYZ coordinate system (global coordinate system) by using acceleration data measured by the acceleration sensor 12. Since the user 2 performs the action in step S4 in FIG. 4, the x axis of the sensor unit 10 matches the X axis of the XYZ coordinate system in terms of direction at address (during standing still) of the user 2, and the y axis of the sensor unit 10 is present on the YZ plane. Therefore, the swing analysis portion 211 can specify the initial attitude of the sensor unit 10 on the basis of the inclined angle α of the shaft of the golf club 3.

The swing analysis portion 211 computes changes in attitudes from the initial attitude of the sensor unit 10 in a time-series manner by performing rotation calculation using angular velocity data which is subsequently measured by the angular velocity sensor 14. An attitude of the sensor unit 10 may be expressed by, for example, rotation angles (a roll angle, a pitch angle, and a yaw angle) about the X axis, the Y axis, and the Z axis, or a quaternion.

The signal processing section 16 of the sensor unit 10 may compute an offset amount of measured data so as to perform bias correction on the measured data, and the acceleration sensor 12 and the angular velocity sensor 14 may have a bias correction function. In this case, it is not necessary for the swing analysis portion 211 to perform bias correction on the measured data.

The swing analysis portion 211 calculates a position of each portion of the golf club 3 at a time point t on the basis of a position and an attitude of the sensor unit 10 at the time point t. A position of a predetermined portion of the golf club 3 at the time point t may be calculated on the basis of a positional relationship from an attachment position of the sensor unit 10 in the golf club 3 to the predetermined portion, the position of the sensor unit 10 at the time point t, and the attitude of the sensor unit 10 at the time point t.

As a result thereof, the swing analysis portion 211 acquires time-series data regarding positions of each portion of the golf club 3. A time interval between positions adjacent to each other included in the time-series data is the same as a sampling cycle Δt of measured data.

In the following description, predetermined portions of the golf club 3 as position calculation targets are two portions such as the head and the grip, but may include other portions of the golf club 3, for example, any one of a predetermined portion of the shaft, an intermediate location of the grip end and the grip, a central position of the golf club 3, and an attachment position of the sensor unit 10.

### 1-11. Detection of Each Timing in Swing

The swing analysis portion 211 of the swing analysis apparatus 20 detects each timing in a swing, for example, as follows.

First, the swing analysis portion 211 detects a timing (impact timing) at which the user 2 hit a ball by using measured data. For example, the swing analysis portion 211 may compute a combined value of measured data (acceleration data or angular velocity data), and may detect an impact timing (time point) on the basis of the combined value.

Specifically, first, the swing analysis portion 211 computes a combined value no (t) of angular velocities at each time point t by using the angular velocity data (bias-corrected angular velocity data for each time point t). For example, if the angular velocity data items at the time point t are respectively indicated by x(t), y(t), and z(t), the swing analysis portion 211 computes the combined value no (t) of the angular velocities according to the following Equation (2).

n₀(t)=\sqrt{x(t)²+y(t)²+z(t)²} (2)

Next, the swing analysis portion 211 converts the combined value n₀(t) of the angular velocities at each time point t into a combined value n(t) which is normalized (scale-conversion) within a predetermined range. For example, if the maximum value of the combined value of the angular velocities in an acquisition period of measured data is max(n₀), the swing analysis portion 211 converts the combined value n₀(t) of the angular velocities into the combined value n(t) which is normalized within a range of 0 to 100 according to the following Equation (3).

$$n ( t ) = \frac{100 \times {n}_{0} ( t )}{max ( {n}_{0} )} \qquad ( 3 )$$

Next, the swing analysis portion 211 computes a derivative dn(t) of the normalized combined value n(t) at each time point t. For example, if a cycle for measuring three-axis angular velocity data items is indicated by Δt, the swing analysis portion 211 computes the derivative (difference) dn(t) of the combined value of the angular velocities at the time point t by using the following Equation (4).

dn(t)=n(t)−n(t−Δt) (4)

Next, of time points at which a value of the derivative dn (t) of the combined value becomes the maximum and the minimum, the swing analysis portion 211 detects the earlier time point as an impact time point t_{impact} (impact timing). It is considered that a swing speed is the maximum at the moment of impact in a typical golf swing. In addition, since it is considered that a value of the combined value of the angular velocities also changes according to a swing speed, the swing analysis portion 211 can capture a timing at which a derivative value of the combined value of the angular velocities is the maximum or the minimum (that is, a timing at which the derivative value of the combined value of the angular velocities is a positive maximum value or a negative minimum value) in a series of swing actions as the impact timing. Since the golf club 3 vibrates due to the impact, a timing at which a derivative value of the combined value of the angular velocities is the maximum and a timing at which a derivative value of the combined value of the angular velocities is the minimum may occur in pairs, and, of the two timings, the earlier timing may be the moment of the impact.

Next, the swing analysis portion 211 detects a time point of a minimum point at which the combined value n(t) is close to 0 before the impact time point t_{impact}, as a top time point tₜₒₚ(top timing). It is considered that, in a typical golf swing, an action temporarily stops at the top after starting the swing, then a swing speed increases, and finally impact occurs. Therefore, the swing analysis portion 211 can capture a timing at which the combined value of the angular velocities is close to 0 and becomes the minimum before the impact timing, as the top timing.

Next, the swing analysis portion 211 sets an interval in which the combined value n(t) is equal to or smaller than a predetermined threshold value before and after the top time point tₜₒₚ, as a top interval, and detects a last time point at which the combined value n(t) is equal to or smaller than the predetermined threshold value before a starting time point of the top interval, as a swing starting (backswing starting) time point tₛₜₐᵣₜ. It is hardly considered that, in a typical golf swing, a swing action is started from a standing still state, and the swing action is stopped till the top. Therefore, the swing analysis portion 211 can capture the last timing at which the combined value of the angular velocities is equal to or smaller than the predetermined threshold value before the top interval as a timing of starting the swing action. The swing analysis portion 211 may detect a time point of the minimum point at which the combined value n(t) is close to 0 before the top time point tₜₒₚ as the swing starting time point tₛₜₐᵣₜ.

The swing analysis portion 211 may also detect each of a swing starting timing, a top timing, an impact timing by using three-axis acceleration data in the same manner.

Detection target timings may include a halfway back timing at which the long axis direction of the golf club 3 becomes a direction along the horizontal direction during the backswing, and a halfway down timing at which the long axis direction of the golf club 3 becomes a direction along the horizontal direction during the downswing. However, in the following description, detection target timings are three timings including the swing starting timing, the top timing, and the impact timing.

### 1-11. Description of Calculation of Variation for Each Section

The variation diagnosis portion 311 of the swing diagnosis apparatus 30 calculates a variation in a plurality of swings selected by the user 2 as follows.

Here, swing numbers m=1, 2, . . . , and Mare allocated to a plurality of swings in order to time points. However, order of allocating the swing number m is not limited to order of time points. Here, a predetermined portion as a variation calculation target is assumed to be the head of the golf club 3, but a variation is similarly calculated for other predetermined portions. Here, a predetermined period as a variation calculation target is assumed to be a period (that is, the backswing period) from the swing starting timing tₛₜₐᵣₜ to the top timing tₜₒₚ, but a variation is similarly calculated for other predetermined periods of a swing.

First, the variation diagnosis portion 311 reads a plurality of swing analysis data items corresponding to a plurality of swings selected by the user 2, from the swing analysis data list 341.

Next, the variation diagnosis portion 311 reads time-series data regarding positions of the head, the swing starting timing tₛₜₐᵣₜ, and the top timing tₜₒₚ, from the plurality of respective swing analysis data items.

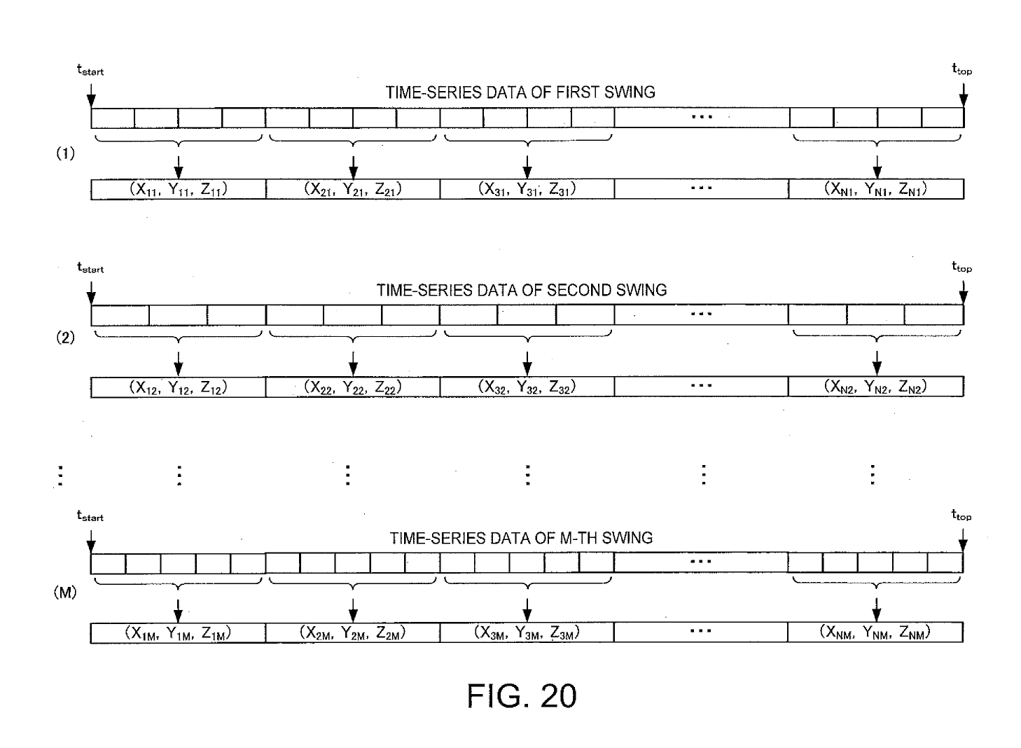

The variation diagnosis portion 311 extracts time-series data for the backswing period (the timing tₛₜₐᵣₜ to the timing tₜₒₚ) from the time-series data of the first swing (an upper part in FIG. 20(1)).

The variation diagnosis portion 311 extracts time-series data for the backswing period (the timing tₛₜₐᵣₜ to the timing tₜₒₚ) from the time-series data of the second swing (an upper part in FIG. 20(2)).

The variation diagnosis portion 311 extracts similar time-series data with respect to the third swing, the fourth swing, . . . , and the M-th swing (upper parts in FIGS. 20(1) . . . , and 20(M)).

Here, times required in swings may be different from each other among the first swing, the second swing, . . . , and the M-th swing. For example, whereas, in a certain swing, the backswing is 800 ms, and the downswing is 260 ms, in another swing, the backswing is 1370 ms, and the downswing is 430 ms.

Thus, even if the same backswing period (the timing tₛₜₐᵣₜ to the timing tₜₒₚ) is extracted, the number of samples of positions included in time-series data may differ among the swings. For example, whereas, in a certain swing, the number of samples of positions during the backswing is 800, and the number of samples of positions during the downswing is 260, in another swing, the number of samples of positions during the backswing is 1370, and the number of samples of positions during the downswing is 430.

FIG. 20 schematically illustrates an example in which data regarding a position is indicated by a single block, and the number of samples of positions included in the time-series data of the second swing is smaller than the number of samples of positions included in the time-series data of the other swings.

Therefore, the variation diagnosis portion 311 divides the time-series data (the upper parts in FIGS. 20(1), . . . , and 20(M)) of each of the first swing, the second swing, . . . , and the M-th swing into sections of a predetermined number N (for example, N=128), and obtains a position (Xₙₘ, Yₙₘ, Zₙₘ) for each swing and for each section (the lower parts in FIGS. 20(1), . . . , and 20(M)). Here, n is a section number (where n=1, . . . , and N), and m is a swing number (where m=1, . . . , and M).

For example, the X coordinate Xₙₘ of a position of the n-th section of the m-th swing is an average value of X coordinates of respective positions in the n-th section, the Y coordinate Yₙₘ of a position of the n-th section of the m-th swing is an average value of Y coordinates of respective positions in the n-th section, and the Z coordinate Zₙₘ of a position of the n-th section of the m-th swing is an average value of Z coordinates of respective positions in the n-th section.

Alternatively, the X coordinate Xₙₘ of a position of the n-th section of the m-th swing is an X coordinate of a representative position in the n-th section, the Y coordinate Yₙₘ of a position of the n-th section of the m-th swing is a Y coordinate of a representative position in the n-th section, and the Z coordinate Zₙₘ of a position of the n-th section of the m-th swing is a Z coordinate of a representative position in the n-th section. The representative position is a single position as a representative of a plurality of positions included in a section.

In the above-described way, each of the plurality of swings is represented by N positions, and thus it becomes easier to calculate a variation in the subsequent processes.

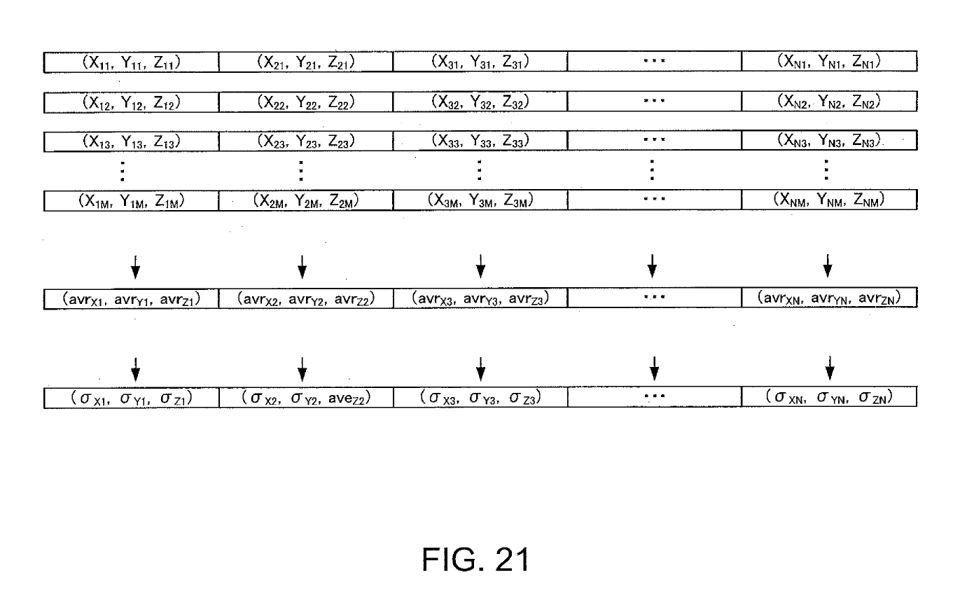

As illustrated in FIG. 21, the variation diagnosis portion 311 calculates a standard deviation σ_{Xn} of the X coordinates Xₙₘ, a standard deviation σ_{Yn} of the Y coordinates Yₙₘ, and a standard deviation σ_{Zn} of the Z coordinates Zₙₘ, for each section number n, as a variation between positions in the first swing, the second swing, . . . , and the M-th swing.

The standard deviation σ_{Xn} of the n-th sections is calculated on the basis of the X coordinates Xₙ₁, Xₙ₂, . . . , and X_{nM} of the n-th sections, an average value avr_{Xn} of the X coordinates Xₙ₁, Xₙ₂, . . . , and X_{nM}, and the number M of swings, for example, according to the following equation.

$${σ}_{Xn} = \sqrt{\frac{{\sum }_{m = 1}^{M} {( {X}_{nm} - {avr}_{Xn} )}^{2}}{M}} \qquad ( 5 )$$

The standard deviation σ_{Yn} of the n-th sections is calculated on the basis of the Y coordinates Yₙ₁, Yₙ₂, . . . , and Y_{nM} of the n-th sections, an average value avr_{Yn} of the Y coordinates Yₙ₁, Yₙ₂, . . . , and Y_{nM}, and the number M of swings, for example, according to the following equation.

$${σ}_{Yn} = \sqrt{\frac{{\sum }_{m = 1}^{M} {( {Y}_{nm} - {avr}_{Yn} )}^{2}}{M}} \qquad ( 6 )$$

The standard deviation σ_{Zn} of the n-th sections is calculated on the basis of the Z coordinates Zₙ₁, Zₙ₂, . . . , and Z_{nM} of the n-th sections, an average value avr_{Zn} of the Z coordinates Zₙ₁, Zₙ₂, . . . , and Z_{nM}, and the number M of swings, for example, according to the following equation.

$${σ}_{Zn} = \sqrt{\frac{{\sum }_{m = 1}^{M} {( {Z}_{nm} - {avr}_{Zn} )}^{2}}{M}} \qquad ( 7 )$$

As mentioned above, if a variation is obtained for each section, an individual variation for each range, such as a variation being great in the vicinity of the top (switching) in the entire swing trajectory, can be presented to the user 2. In the related art, a plurality of swing trajectories are simply displayed to overlap each other, and thus only a specific scalar amount (single value) such as a carry or a direction of a hit ball can be presented to the user 2.

In the present embodiment, for example, if each of a variation related to the head and a variation related to the grip is calculated, the user 2 can compare deviation of the grip with deviation of the head, or to what extent the deviation of the head is greater than the deviation of the grip can be presented to the user 2.

In the present embodiment, since variations are calculated with respect to the X axis direction, the Y axis direction, and the Z axis direction, a direction in which a variation is great can be presented to the user 2.

The variation diagnosis portion 311 sets temporal lengths of the above-described N sections to be uniform. However, the variation diagnosis portion 311 may set spatial lengths of the above-described N section to be uniform (for example, a trajectory passing through a plurality of positions may be regarded as a circular arc, and N sections may be set by dividing the circular arc so that central angles from the center of the circular arc are uniform).

Whether a temporal length or a spatial length is uniform may be designated by the user 2. The designation by the user 2 is performed on, for example, the selection screen in FIG. 7. The content designated by the user 2 is input to the swing analysis apparatus 20 via, for example, the operation section 23, and is recognized by the processing section 21. The swing analysis apparatus 20 transmits the above-described selection information including the content designated by the user 2, to the swing diagnosis apparatus 30.

### 1-12. Swing Analysis Data Generation Process

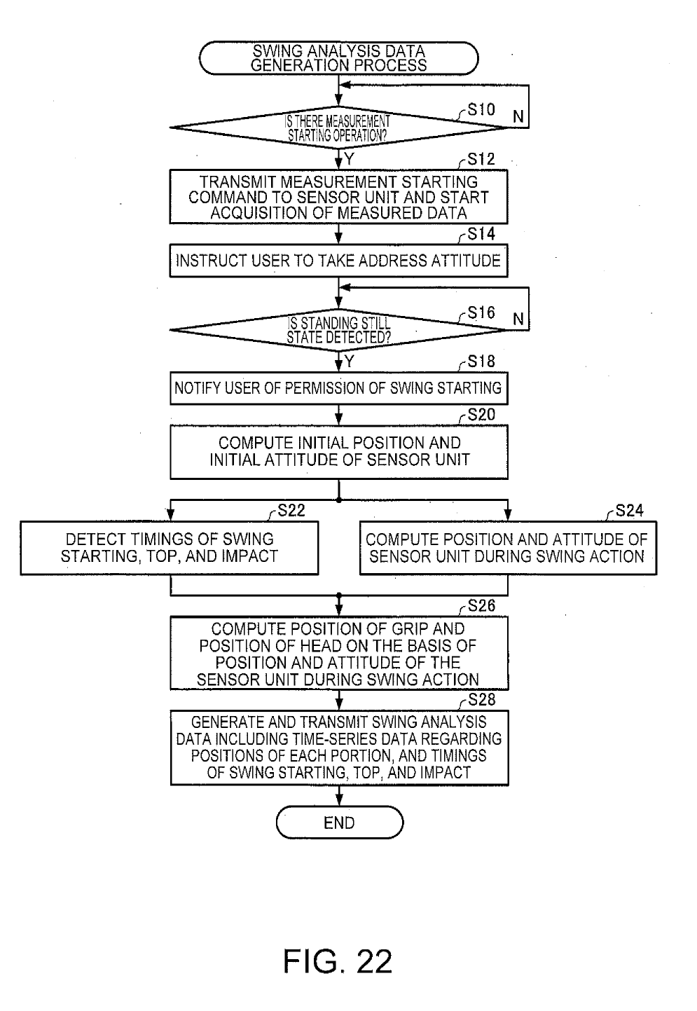

FIG. 22 is a flowchart illustrating examples of procedures of a swing analysis data generation process performed by the processing section 21 of the swing analysis apparatus 20. The processing section 21 performs the swing analysis data generation process, for example, according to the procedures shown in the flowchart of FIG. 22 by executing the swing analysis program 240 stored in the storage section 24. Hereinafter, the flowchart of FIG. 22 will be described.

Step S10: The processing section 21 waits for the user 2 to perform a measurement starting operation (N in S10), and proceeds to the next step S12 if the measurement starting operation is performed (Y in S10).

Step S12: The processing section 21 transmits a measurement starting command to the sensor unit 10, and starts to acquire measured data from the sensor unit 10.

Step S14: The processing section 21 instructs the user 2 to take an address attitude. The user 2 takes the address attitude in response to the instruction, and stands still.

Step S16: The processing section 21 waits for a standing still state of the user 2 to be detected by using the measured data acquired from the sensor unit 10 (N in S16), and proceeds to step S18 if the standing still state is detected (Y in S16).

Step S18: The processing section 21 notifies the user 2 of permission of swing starting. The processing section 21 outputs, for example, a predetermined sound, or an LED is provided in the sensor unit 10, and the LED is lighted, so that the user 2 is notified of permission of swing starting. The user 2 confirms the notification and then starts a swing action. The processing section 21 performs processes in step S20 and subsequent steps after completion of the swing action of the user 2, or from before completion of the swing action.

Step S20: The processing section 21 computes an initial position and an initial attitude of the sensor unit 10 by using the measured data (measured data during standing still (at address) of the user 2) acquired from the sensor unit 10.

Step S22: The processing section 21 detects a swing starting timing, a top timing, and an impact timing by using the measured data acquired from the sensor unit 10.

Step S24: The processing section 21 computes a position and an attitude of the sensor unit 10 during the swing action of the user 2 in parallel to the process in step S22, or before and after the process in step S22.

Step S26: The processing section 21 computes a position of the grip and a position of the head on the basis of the position and the attitude of the sensor unit 10 during the swing action. Step S26 may be executed after step S24 is executed, and may be executed in parallel to step S24.

Step S28: The processing section 21 generates swing analysis data including time-series data regarding positions of the grip, time-series data regarding positions of the head, and pieces of information indicating the respective timings, and finishes the flow of the swing analysis data generation process. The swing analysis data is transmitted from the swing analysis apparatus 20 to the swing diagnosis apparatus 30.

In the flowchart of FIG. 22, order of the respective steps may be changed as appropriate within an allowable range, some of the steps may be omitted or changed, and other steps may be added thereto.

### 1-13. Processes in Swing Analysis Apparatus 20 and Swing Diagnosis Apparatus 30

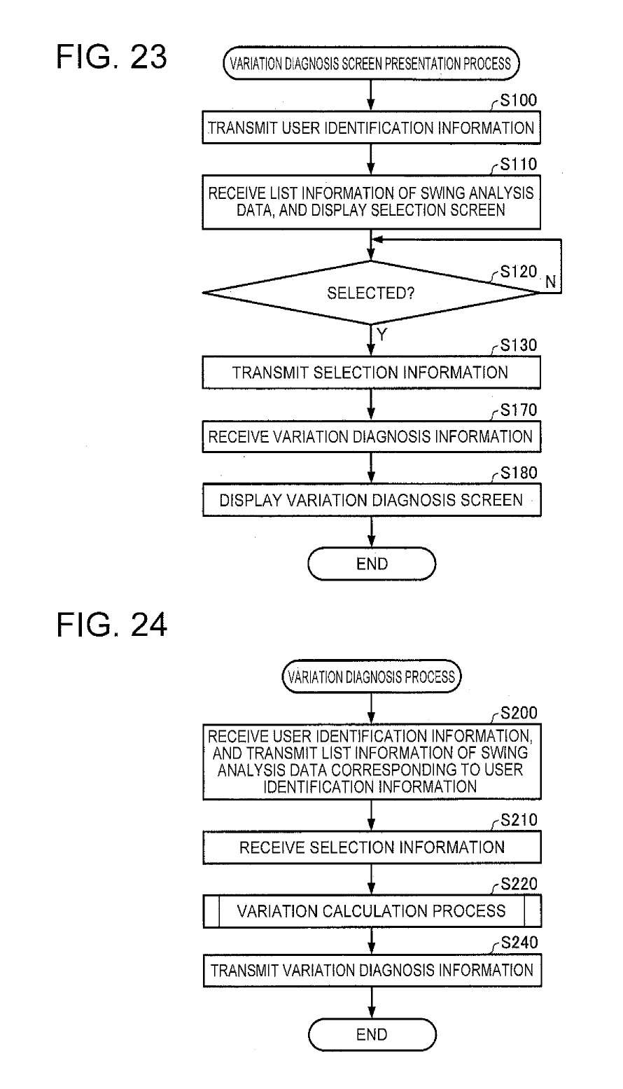

FIG. 23 is a flowchart illustrating examples of procedures of a variation diagnosis screen presentation process (an example of a method) performed by the processing section 21 of the swing analysis apparatus 20. The processing section 21 performs the variation diagnosis screen presentation process, for example, according to the procedures shown in the flowchart of FIG. 23 by executing the swing analysis program 240 stored in the storage section 24.

FIG. 24 is a flowchart illustrating examples of procedures of a variation diagnosis process (an example of a method) performed by the processing section 31 of the swing diagnosis apparatus 30. The processing section 31 of the swing diagnosis apparatus 30 performs the variation diagnosis process, for example, according to the procedures shown in the flowchart of FIG. 24 by executing the variation diagnosis program 340 stored in the storage section 34.

Hereinafter, the flowcharts of FIGS. 23 and 24 will be described together with each other.

Step S100 in FIG. 23: The processing section 21 of the swing analysis apparatus 20 transmits user identification information allocated to the user 2, to the swing diagnosis apparatus 30.

Step S200 in FIG. 24: The processing section 31 of the swing diagnosis apparatus 30 receives the user identification information, and transmits list information of the swing analysis data corresponding to the user identification information.

Step S110 in FIG. 23: The processing section 21 of the swing analysis apparatus 20 receives the list information of the swing analysis data, and displays a selection screen (FIG. 7) of the swing analysis data on the display section 25.

Step S120 in FIG. 23: The processing section 21 of the swing analysis apparatus 20 waits for the swing analysis data to be selected by the user 2 on the selection screen of the swing analysis data (N in S120), and proceeds to step S130 if selection is performed (Y in S120).

Step S130 in FIG. 23: The processing section 21 of the swing analysis apparatus 20 transmits selection information indicating the content selected by the user 2.

Step S210 in FIG. 24: The processing section 31 of the swing diagnosis apparatus 30 receives the selection information.

Step S220 in FIG. 24: The processing section 31 of the swing diagnosis apparatus 30 performs a variation calculation process on the basis of the selection information, so as to acquire a variation (variation diagnosis information) for each section. A flow of the variation calculation process will be described later.

Step S240 in FIG. 24: The processing section 31 of the swing diagnosis apparatus 30 transmits the variation diagnosis information.

Step S170 in FIG. 23: The processing section 21 of the swing analysis apparatus 20 receives the variation diagnosis information.

Step S180 in FIG. 23: The processing section 21 of the swing analysis apparatus 20 displays a variation diagnosis screen (for example, any one of the variation diagnosis screens illustrated in FIGS. 8 to 16) on the display section 25, and finishes the flow.

In the flowchart of FIG. 23, order of the respective steps may be changed as appropriate within an allowable range, some of the steps may be omitted or changed, and other steps may be added thereto. Similarly, in the flowchart of FIG. 24, order of the respective steps may be changed as appropriate within an allowable range, some of the steps may be omitted or changed, and other steps may be added thereto.

### 1-14. Variation Calculation Process

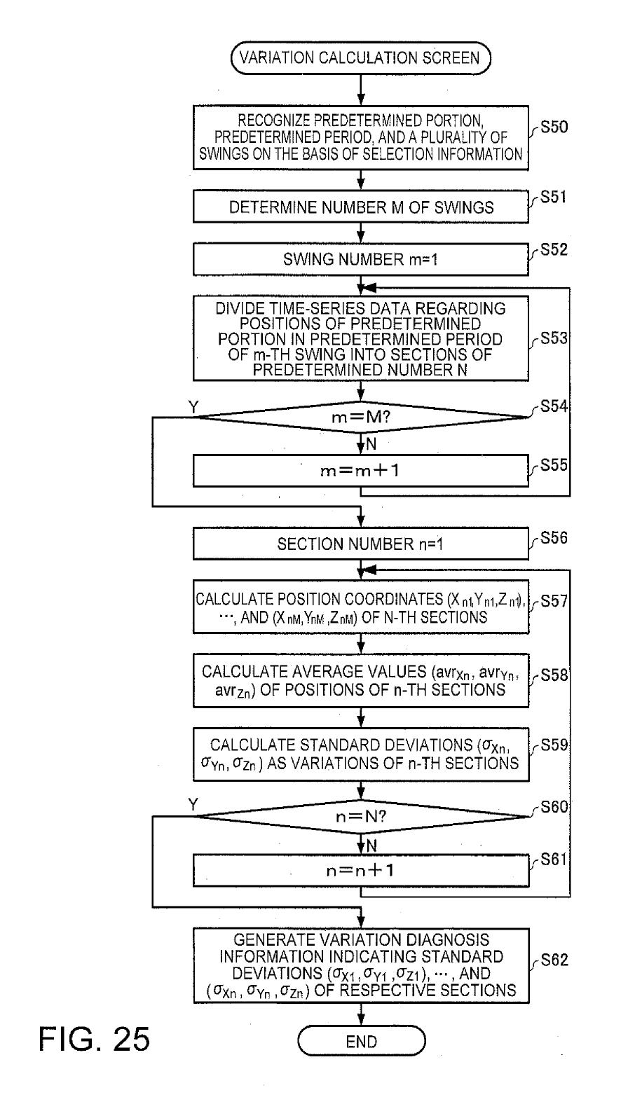

FIG. 25 is a flowchart illustrating examples of procedures of a variation calculation process performed by the processing section 31 of the swing diagnosis apparatus 30. The processing section 31 of the swing diagnosis apparatus 30 performs the variation calculation process, for example, according to the procedures shown in the flowchart of FIG. 25 by executing the variation diagnosis program 340 stored in the storage section 34.

Hereinafter, the flowchart of FIG. 25 will be described.

Step S50: The processing section 31 recognizes the content selected by the user 2 on the basis of the received selection information. Hereinafter, a portion selected by the user 2 will be referred to as a “predetermined portion”, a period selected by the user 2 will be referred to as a “predetermined period”, and a plurality of swings selected by the user 2 will be referred to as “a plurality of swings”.

Step S51: The processing section 31 sets a value of the number M of swings to be the same as the number of the plurality of swings.

Step S52: The processing section 31 sets a value of a swing number m to 1.

Step S53: The processing section 31 divides time-series data regarding positions of the predetermined portion in the predetermined period of the m-th swing into sections of a predetermined number N.

Step S54: The processing section 31 determines whether or not the swing number m reaches M, proceeds to step S56 if the swing number m reaches M, and proceeds to step S55 if the swing number m does not reach M.

Step S55: The processing section 31 increases the swing number m by 1, and proceeds to step S53.

Step S56: The processing section 31 sets the section number n to 1.

Step S57: The processing section 31 calculates position coordinates (Xₙ₁, Yₙ₁, Zₙ₁), . . . , and (X_{nM}, Y_{nM}, Z_{nM}) of the n-th sections.

Step S58: The processing section 31 calculates average values (avr_{Xn}, avr_{Yn}, avr_{Zn}) of positions of the n-th sections.

Step S59: The processing section 31 calculates standard deviations (σ_{Xn}, σ_{Yn}, σ_{Zn}) as variations of the n-th sections.

Step S60: The processing section 31 determines whether or not the section number n reaches N, proceeds to step S62 if the section number n reaches N, and proceeds to step S61 if the section number n does not reach N.

Step S61: The processing section 31 increases the section number n by 1, and proceeds to step S57.

Step S62: The processing section 31 generates variation diagnosis information indicating standard deviations (σ_{X1}, σ_{Y1}, σ_{Z1}), . . . , and (σ_{Xn}, σ_{Yn}, σ_{Zn}) of the respective sections, and finishes the flow.

Herein, a description has been made of a case where there is a single combination of a portion selected by the user 2, a period selected by the user 2, and a plurality of swings selected by the user 2, but, in a case where there are a plurality of combinations, the flow of FIG. 25 is assumed to be performed on each of the plurality of combinations. In this case, variation diagnosis information is generated by the number of combinations.

In the flowchart of FIG. 25, order of the respective steps may be changed as appropriate within an allowable range, some of the steps may be omitted or changed, and other steps may be added thereto.

### 2. Appendix of Embodiment

In the above-described embodiment, the processing section 31 of the swing diagnosis apparatus 30 obtains a standard deviation of positions of respective sections as an index indicating a variation between the positions of the respective sections, but may obtain other indexes indicating a variation, such as a distribution range of positions of respective sections, the maximum difference between positions of respective sections, and an average absolute deviation of positions of respective sections.

In the swing diagnosis system 1 of the above-described embodiment, predetermined portions as variation calculation targets include the head of the golf club 3 and the grip of the golf club 3, but may include an intermediate location between the grip end and the grip, a central location of the golf club 3, an attachment location of the sensor unit 10, portions (for example, the wrist, the arm, and the shoulder) of the body of the user, and other portions.

In the swing diagnosis system 1 of the above-described embodiment, variation diagnosis information is generated and presented, but other information may be generated and presented in addition to the variation diagnosis information. Other diagnosis (user's comprehensive diagnosis or the like) may be performed on the basis of the above-described variation diagnosis information.

In the swing diagnosis system 1 of the above-described embodiment, predetermined periods as variation calculation targets include at least one of the entire swing, the backswing period, and the downswing period, but may include other periods in a swing, for example, a period from swing starting to halfway back, and a period from halfway down to impact.

In the swing diagnosis system 1 of the above-described embodiment, a swing as a variation diagnosis target is limited to a swing of the user 2, but variation diagnosis on a swing of the user 2 and variation diagnosis on a swing of a third party (for example, an expert) may be performed so that the user 2 can recognize a difference between a variation in the swing of the user 2 and a variation in the swing of the expert through comparison.

In the swing diagnosis system 1 of the above-described embodiment, the sensor unit 10 is attached to the golf club 3, but may be attached to the body (the wrist, the arm, the shoulder, or the like) of the user 2.

In the swing diagnosis system 1 of the above-described embodiment, the number of sensor units 10 is one, but may be plural. A plurality of sensor units 10 may be attached to a plurality of portions of the golf club 3 or the body of the user 2, and the swing analysis apparatus 20 may perform a swing analysis process by using measured data from the plurality of sensor units 10.

### 3. Operations and Effects of Embodiment

(1) An electronic apparatus (swing analysis apparatus 20) according to the present embodiment includes a presentation portion (the display section 25 or the sound output section 26) that divides each of time-series data items regarding a plurality of swings of an exercise equipment (golf club 3) into sections of a predetermined number (N), and presents a variation between the time-series data items in the swings for each section (refer to FIGS. 8 to 16, particularly, FIGS. 11 to 16).

The presentation portion (the display section 25 or the sound output section 26) presents a variation for each section by equally setting the number of sections among the plurality of time-series data items even if the number of samples differs among the plurality of time-series data items. The variation for each section is an index which quantitatively indicates deviation of a plurality of swing trajectories in detail. Therefore, the electronic apparatus (swing analysis apparatus 20) according to the present embodiment can objectively estimate reproducibility of a swing.

(2) In the electronic apparatus (swing analysis apparatus 20) according to the present embodiment, the presentation portion (the display section 25 or the sound output section 26) presents the variation along with a predetermined region, the predetermined region is a region interposed between a first plane (shaft plane) along a longitudinal direction of the exercise equipment and a second plane (a Hogan plane or a shoulder plane) passing through the vicinity of the shoulder of a user, the first plane (shaft plane) is a plane specified by a first axis along a target hit ball direction and a second axis along the longitudinal direction of the exercise equipment before starting the swing, and the second plane is a plane (Hogan plane) which includes the first axis and forms a predetermined angle with the first plane, or a plane (shoulder plane) which is parallel to the first plane.

Therefore, the user can check a relationship between the predetermined region and the variation.

(3) An electronic apparatus (swing diagnosis apparatus 30) according to the present embodiment includes a calculation portion (variation diagnosis portion 311) that divides each of a plurality of time-series data items regarding a plurality of swings into sections of a predetermined number, and calculates a variation between the time-series data items in the swings for each section.

The calculation portion (variation diagnosis portion 311) calculates a variation for each section by equally setting the number of sections among the plurality of time-series data items even if the number of samples differs among the plurality of time-series data items. The variation for each section is an index which quantitatively indicates deviation of a plurality of swing trajectories in detail. Therefore, the electronic apparatus (swing diagnosis apparatus 30) according to the present embodiment can objectively estimate reproducibility of a swing.

(4) In the electronic apparatus (swing diagnosis apparatus 30) according to the present embodiment, the calculation portion (variation diagnosis portion 311) divides each of the plurality of time-series data items regarding positions of an exercise equipment (golf club 3) or a user's body into sections of a predetermined number, calculates the positions for each swing and for each section, and calculates a variation between the positions in swings for each section on the basis of the positions for each swing and for each section, an average of the positions in the swings for each section, and the number of swings.

The calculation portion (variation diagnosis portion 311) calculates a variation between the positions in swings for each section on the basis of the positions for each swing and for each section, an average of the positions in the swings for each section, and the number of swings. Therefore, the electronic apparatus (swing diagnosis apparatus 30) can acquire, for example, a standard deviation as a value for each section.

(5) In the electronic apparatus (swing diagnosis apparatus 30) according to the present embodiment, each of the positions for each section is an average value or a representative value of the positions in the section.

The calculation portion (variation diagnosis portion 311) calculates an average value or a representative value of the positions in the section as each of the positions for each section. Therefore, the calculation portion (variation diagnosis portion 311) can reliably reduce the number of samples of positions required to calculate a variation.

(6) In the electronic apparatus (swing diagnosis apparatus 30) according to the present embodiment, the variation is a standard deviation.

Therefore, the electronic apparatus (swing diagnosis apparatus 30) can acquire a standard deviation as a variation for each section.

(7) In the electronic apparatus (swing diagnosis apparatus 30) according to the present embodiment, the calculation portion (variation diagnosis portion 311) calculates the variation on the basis of output from an inertial sensor (sensor unit 10).

The inertial sensor (sensor unit 10) can accurately measure a position of a predetermined portion of an exercise equipment or a user. Therefore, the calculation portion (variation diagnosis portion 311) can accurately calculate a variation compared with a case of calculating a variation on the basis of a swing image or the like.

(8) In the electronic apparatus (the swing analysis apparatus 20 or the swing diagnosis apparatus 30) according to the present embodiment, the time-series data is at least one of time-series data from starting of the swing to impact (the entire swing), time-series data from starting of the swing to a top (backswing), and time-series data from the top to the impact (downswing).

Therefore, the electronic apparatus (the swing analysis apparatus 20 or the swing diagnosis apparatus 30) according to the embodiment can set, as a variation presentation target or calculation target, a period from a predetermined timing of the swing to another predetermined timing thereof.

(9) In the electronic apparatus (the swing analysis apparatus 20 or the swing diagnosis apparatus 30) according to the present embodiment, temporal lengths of the sections of the predetermined number are set to be uniform.

Therefore, the electronic apparatus (the swing analysis apparatus 20 or the swing diagnosis apparatus 30) can present or calculate a variation for each section which is uniform in a time direction.

(10) In the electronic apparatus (the swing analysis apparatus 20 or the swing diagnosis apparatus 30) according to the present embodiment, spatial lengths of the sections of the predetermined number are set to be uniform.

Therefore, the electronic apparatus (the swing analysis apparatus 20 or the swing diagnosis apparatus 30) can present or calculate a variation for each section which is uniform in a space direction.

(11) A system (swing diagnosis system 1) according to the present embodiment includes the electronic apparatus (the swing analysis apparatus 20 or the swing diagnosis apparatus 30) according to the present embodiment and the inertial sensor (sensor unit 10).

Therefore, for example, if the inertial sensor is mounted on, for example, an exercise equipment or a user's body, the electronic apparatus (the swing analysis apparatus 20 or the swing diagnosis apparatus 30) can present or calculate a variation for each section on the basis of output from the inertial sensor. The variation for each section is an index which quantitatively indicates deviation of a plurality of swing trajectories in detail. Therefore, according to the system (swing diagnosis system 1) of the present embodiment, it is possible to objectively estimate reproducibility of a swing.

(12) A method (variation diagnosis screen presentation process) according to the present embodiment includes a presentation procedure (S180) of dividing each of time-series data items regarding a plurality of swings of an exercise equipment (golf club 3) into sections of a predetermined number, and presenting a variation between the time-series data items in the swings for each section.

In the presentation procedure (S180), a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the method (variation diagnosis screen presentation process) of the present embodiment, it is possible to objectively estimate reproducibility of a swing.

(13) A method (variation diagnosis process) according to the present embodiment includes a calculation procedure (S220) of dividing each of time-series data items regarding a plurality of swings of an exercise equipment (golf club 3) into sections of a predetermined number, and calculating a variation between the time-series data items in the swings for each section.

In the calculation procedure (S220), a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the method (variation diagnosis process) of the present embodiment, it is possible to objectively estimate reproducibility of a swing.

(14) A program (swing analysis program) according to the present embodiment causes a computer (processing section 21) to execute a presentation procedure (S180) of dividing each of time-series data items regarding a plurality of swings of an exercise equipment (golf club 3) into sections of a predetermined number, and presenting a variation between the time-series data items in the swings for each section.

In the presentation procedure (S180), a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the program (swing analysis program) of the present embodiment, it is possible to objectively estimate reproducibility of a swing.

(15) A program (variation diagnosis program) according to the present embodiment causes a computer (processing section 31) to execute a calculation procedure (S220) of dividing each of time-series data items regarding a plurality of swings of an exercise equipment (golf club 3) into sections of a predetermined number, and calculating a variation between the time-series data items in the swings for each section.

In the calculation procedure (S220), a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the program (variation diagnosis program) of the present embodiment, it is possible to objectively estimate reproducibility of a swing.

(16) A recording medium according to the present embodiment records a program (swing analysis program) causing a computer to execute a presentation procedure (S180) of dividing each of time-series data items regarding a plurality of swings of an exercise equipment (golf club 3) into sections of a predetermined number, and presenting a variation between the time-series data items in the swings for each section.

In the presentation procedure (S180), a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the recording medium of the present embodiment, it is possible to objectively estimate reproducibility of a swing.

(17) A recording medium according to the present embodiment records a program (variation diagnosis program) causing a computer to execute a calculation procedure (S220) of dividing each of time-series data items regarding a plurality of swings of an exercise equipment (golf club 3) into sections of a predetermined number, and calculating a variation between the time-series data items in the swings for each section.

In the calculation procedure (S220), a variation for each section is presented by equally setting the number of sections among the plurality of time-series data items even if the number of samples differs among the plurality of time-series data items. The variation for each section is an index which quantitatively indicates deviation of a plurality of swing trajectories in detail. Therefore, according to the recording medium of the present embodiment, it is possible to objectively estimate reproducibility of a swing.

### 4. Other Modification Examples

The invention is not limited to the present embodiment, and may be variously modified within the scope of the spirit of the invention.

In the above-described embodiment, the acceleration sensor 12 and the angular velocity sensor 14 are built into and are thus integrally formed as the sensor unit 10, but the acceleration sensor 12 and the angular velocity sensor 14 may not be integrally formed. Alternatively, the acceleration sensor 12 and the angular velocity sensor 14 may not be built into the sensor unit 10, and may be directly mounted on the golf club 3 or the user 2.

In the above-described embodiment, the sensor unit 10 and the swing analysis apparatus 20 are separately provided, but may be integrally formed so as to be attached to the golf club 3 or the user 2. The sensor unit 10 may have some of the constituent elements of the swing analysis apparatus 20 along with the inertial sensor (for example, the acceleration sensor 12 or the angular velocity sensor 14).

In other words, some or all of the functions of the swing analysis apparatus 20 may be installed on the sensor unit 10 side, and some of the functions of the sensor unit 10 may be installed on the swing analysis apparatus 20 side.

In other words, some or all of the functions of the swing analysis apparatus 20 may be installed on the swing diagnosis apparatus 30 side. Some of the functions of the swing diagnosis apparatus 30 may be installed on the swing analysis apparatus 20 side.

In the above-described embodiments, an inertial sensor (sensor unit 10) of a type of being attached to the golf club 3 has been described, but the inertial sensor (an acceleration sensor and an angular velocity sensor) may be built into the golf club 3.

In the above-described embodiment, the swing analysis system analyzing a golf swing has been exemplified, but the invention is applicable to a swing analysis system diagnosing a swing in various sports such as tennis or baseball.

The above-described embodiment and modification examples are only examples, and the invention is not limited thereto. For example, the embodiments and the respective modification examples may be combined with each other as appropriate.

For example, the invention includes substantially the same configuration (for example, a configuration in which functions, methods, and results are the same, or a configuration in which objects and effects are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

The entire disclosure of Japanese Patent Application No. 2015-215810 filed Nov. 2, 2015 is expressly incorporated by reference herein.

What is claimed is:

1. A presentation method comprising:
dividing each of time-series data items regarding a plurality of swings of an exercise equipment into sections of a predetermined number, and presenting a variation between the time-series data items in the swings for each section.

2. The presentation method according to claim 1,
wherein the variation is presented along with a predetermined region, and
wherein the predetermined region is a region interposed between a first plane along a longitudinal direction of the exercise equipment and a second plane passing through the vicinity of the shoulder of a user, the first plane being a plane specified by a first axis along a target hit ball direction and a second axis along the longitudinal direction of the exercise equipment before starting the swing, and the second plane being a plane which includes the first axis and forms a predetermined angle with the first plane, or a plane which is parallel to the first plane.

3. The presentation method according to claim 1,
wherein the time-series data is at least one of time-series data from starting of the swing to impact, time-series data from starting of the swing to a top, and time-series data from the top to the impact.

4. The presentation method according to claim 1,
wherein temporal lengths of the sections of the predetermined number are set to be uniform.

5. The presentation method according to claim 1,
wherein spatial lengths of the sections of the predetermined number are set to be uniform.

6. The presentation method according to claim 1,
wherein the variation is displayed in a space.

7. An electronic apparatus comprising:
a calculation portion that divides each of a plurality of time-series data items regarding a plurality of swings into sections of a predetermined number, and calculates a variation between the time-series data items in the swings for each section.

8. The electronic apparatus according to claim 7,
wherein the calculation portion divides each of the plurality of time-series data items regarding positions of an exercise equipment into sections of a predetermined number, calculates the positions for each swing and for each section, and calculates a variation between the positions in swings for each section on the basis of the positions for each swing and for each section, an average of the positions in the swings for each section, and the number of swings.

9. The electronic apparatus according to claim 8,
wherein each of the positions for each section is an average value or a representative value of the positions in the section.

10. The electronic apparatus according to claim 8,
wherein the variation is a standard deviation.

11. The electronic apparatus according to claim 7,
wherein the calculation portion calculates the variation on the basis of output from an inertial sensor.

12. The electronic apparatus according to claim 7,
wherein the time-series data is at least one of time-series data from starting of the swing to impact, time-series data from starting of the swing to a top, and time-series data from the top to the impact.

13. The electronic apparatus according to claim 7,
wherein temporal lengths of the sections of the predetermined number are set to be uniform.

14. The electronic apparatus according to claim 7,
wherein spatial lengths of the sections of the predetermined number are set to be uniform.

15. A system comprising:
the electronic apparatus according to claim 11; and
the inertial sensor.

16. A recording medium recording a program causing a computer to execute:
a procedure of dividing each of time-series data items regarding a plurality of swings of an exercise equipment into sections of a predetermined number, and calculating a variation between the time-series data items in the swings for each section.
